(19) United States
(12) Patent Application Publication
(10) Pub. No.: US 2019/0134534 A1
(43) Pub. Date: May 9, 2019

(54) CONTINUOUS MOVING BED CHROMATOGRAPHY

(71) Applicant: Michael Anton, Paris (FR)

(72) Inventor: Michael Anton, Paris (FR)

(21) Appl. No.: 16/302,083

(22) PCT Filed: May 17, 2017
(86) PCT No.: PCT/GB2017/051382

§ 371 Date: Nov. 15, 2018

(30) Foreign Application Priority Data
May 18, 2016 (GB) 1608759.5

(51) Int. Cl. B01D 15/38; G01N 30/58; G01N 30/46; G01N 30/44; B01D 15/02; B01D 15/18

(52) U.S. Cl. CPC B01D 15/3885; G01N 30/58; G01N 30/467; B01D 15/1807; B01D 15/02; B01D 15/1885; G01N 30/44

(57) ABSTRACT

An apparatus and method for carrying out continuous true moving bed chromatography using strong magnetic fields. More particularly the invention enables counter-flow moving bed chromatography with much better efficiency than batch chromatography; and with design and operation much simpler than simulated moving bed chromatography.

### FIELD OF THE INVENTION

The invention relates to continuous chromatography using moving bed columns. The beds may move either co-currently or counter-currently to the fluid phase or at an arbitrary angle. The invention consists of an apparatus and method for carrying out the chromatography using strong magnetic fields to move the bed. One such apparatus performing a unit operation is called a continuous magnetic unit.

### BACKGROUND OF THE INVENTION

When a chemical or biochemical process has one or more steps of chromatography involving a solid and one or more fluid phases, operating it continuously requires either several columns set in parallel or the use of moving bed chromatography. Using columns in parallel is the simpler method: while one or more columns are loaded, the others are eluted and regenerated. The flow is still interrupted but the chromatographic unit functions continuously when integrated in the wider process. The main advantage is operating in the same conditions as batch chromatography. The main drawback is the use of duplicated columns; the number of columns required is proportional to the ratio of the time of elution and regeneration to the time of loading.

Systems performing true moving bed chromatography have been difficult to design because the solid and fluid phases must be actuated independently, and their industrial use has remained marginal; a rare example makes use of centrifugation to induce radial fluid flow while the solid phase is pumped axially [1]. Simulated moving bed systems have been developed and function in counterflow: several columns are connected in a sequence with valves in-between that control incoming and outgoing lines; the incoming lines of the feed solution and eluent, and the outgoing lines of the waste solution and eluate are switched regularly in order to emulate a packed bed moving counter to the flow of the fluid phase. Each column is loaded, washed, eluted and regenerated in turn. Simulated moving bed systems have found several industrial applications: purification of para-xylene from a mixture of C8 aromatic compounds [2], isolation of normal paraffins from a mixture of normal paraffins, iso-paraffins and aromatic hydrocarbons [3], separation of fructose from a mixture of sugars [4] and recovery of some isomers and enantiomers during the synthesis of pharmaceutical active compounds [5]. Companies producing of monoclonal antibodies have recently started to investigate the use simulated moving beds for purification [6] and [7].

Counterflow moving bed chromatography has advantages over conventional column chromatography other than enabling continuous processing: higher yield at same purity, reduced eluent usage and scaled-down equipment. However the fine chemical industry and the biochemical industry have not adopted it. Their reluctance stems from the design complexity and from the operational difficulty of such a process. The design is complex because (1) the transitions between the four solutions in the fluid phase involve transient mixing which is hard to analyse and (2) the system has many parameters to be optimised for. The operation is difficult because (1) the timing of valves in order to correctly switch between the lines is strict and (2) little flexibility exists to handle the variability of the incoming feed. Lastly, separating more than one component from a mixture greatly increases the already high complexity.

The invention is an apparatus creating a true moving bed column by surrounding the column with a set of strong permanent magnets whose motion induces and controls the movement of the bed. The bed is made of magnetic materials encapsulated in chromatographic materials. The design and operation of such a column is markedly less complicated than a simulated moving bed system.

Functionalised paramagnetic and superparamagnetic particles manipulated by external magnetic fields have already been used in purification processes. The oldest processes involve magnetically assisted fluidised bed reactors. They have had industrial applications for decades both with gas flows and with liquid flows. The reactor is a column in which the fluid is injected at the bottom and flows upward. The bed is made of magnetic particles and expands from a packed state to a fluidised state under the drag of the fluid. The particles remain in the column under their own weight. A set of electromagnets outside the column generates a magnetic field: the magnetic field is almost always parallel or perpendicular to the axis of the column; in rare cases the magnetic field has other configurations. The magnetic field may be static, alternating or pulsating. The role of the magnetic field is to control the mixing of particles and increase to contact between the fluid and the solid. Such magnetic fluidised bed reactors have been used to extract contaminants out of a useful fluid. Usually they are not used to concentrate a useful substance from a feed; a rare example is described in [13].

A process for continuous chromatography using a fluidised bed moving transversally to the fluid is described in [8]. The bed consists either of particles composed of a magnetic part and of an adsorbent part, or of a mixture of magnetisable particles and adsorbent particles. In the column the fluid flow has an upward component which fluidises the bed and a horizontal component which continuously carries the bed from one end of the column to the other. An external magnetic field is applied to stabilise the bed and reduce back-mixing. The mixture to be separated is injected at one end of the column, flows with the carrier fluid and its components are separated based on their adsorption-desorption properties. Each component may be continuously retrieved along the horizontal path of the bed.

The flocculation of paramagnetic and superparamagnetic particles can also be influenced by an external magnetic field. Either the particles may be prompted to remain isolated and the fluidised bed is homogenised. Or they may be prompted to aggregate at controlled rates; thus the sedimentation rates can be controlled with the external magnetic field. An example of continuous dealkalisation of water with fluidised bed reactors is described in [11] at laboratory scale and in [12] at pilot scale.

Magnetic beds have also been designed for use in microfluidic chips [9,10]. They make use of static magnets and can be tuned to function both in packed mode and in fluidised mode. They have been demonstrated to perform immunocapture.

A common batch-wise method for purifying or for extracting a substance from a solution using magnetic particles is high-gradient magnetic separation. The separator consists of non-magnetic vessel surrounded either by electromagnets or by permanent magnets. Inside the vessel a steel mesh concentrates the field lines and creates a high gradient in the magnetic field in their immediate vicinity. The strength of the magnetic field generated by the magnets is usually in the range 0.3 T to 1.3 T. The magnetic field in the magnetic separator can be turned off either by stopping the current flow in the electromagnets of by removing the permanent magnets. The purification process is divided in 6 steps: (1) Superparamagnetic beads are added to the feed solution and the substance reacts with functional groups on the surface of the beads or adsorbs onto them. The solution is stirred for thorough mixing. (2) The solution is flown through the magnetic separator and the beads agglutinate onto the wires. (3) A wash buffer is flown through the magnetic separator. (4) The elution buffer is introduced in the separator, the magnetic field is turned off, and the solution is stirred to suspend the beads and ensure good mixing. (5) The magnetic field is turned on, the particles agglutinate on the wires, and the elution buffer flows out carrying the substance with it. (6) The magnetic field is turned off, the storage buffer of the beads flows in the separator and carries the beads with it. High-gradient magnetic separation is used on industrial scale in the mining industry for concentrating the ores of iron, nickel, cobalt and rare earth elements; in the paper industry for brightening kaolin clays; in the recycling industry for recovering some metals from municipal waste; in the treatment of waste water. Several lab and pilot scale processes have been developed for the purification of proteins. In [16] trypsin was purified from 0.4 L of porcine pancreatin with a yield of 60%. In [15] histidine-tagged Green Fluorescent Protein was purified from 2.4 L of Escherichia coli lysate with a yield above 90%. In [14] the separator is different: four magnets are positioned in parallel Teflon tubes inside the non-magnetic vessel and the magnetic beads agglutinate on the tubes. 100 L of a solution containing a monoclonal antibody were processed in 4 hours with protein A beads; the overall yield was 75%. In [18] the separator uses a novel magnetic design using permanent magnets and its throughput reaches 100 L/h. Its performance is demonstrated by purifying the protein Bowman-Birk Inhibitor from soy-whey.

In a variant of high-gradient magnetic separation named magnetic enhanced centrifugation [17], the steel mesh is replaced by thin horizontal steel bars supported by a central rod; the set of bars is named the wire matrix. The wire matrix spins up to 4000 revolutions per minute. During batch-wise operation, magnetic beads agglutinate on the bars and slide outwardly; as a result they are more spread out than without centrifugation. During continuous operation the magnetic beads detach from the bar when they reach its end then flow to a screw decanter from which they are flushed by a clean buffer. The flow rate was 50 L/h.

Continuous magnetic extraction is another separation method making use of magnetic beads [19,20,21]. An aqueous micellar two-phase system consists of two liquid phases: a surfactant poor phase at the bottom and a surfactant rich phase at the top. Hydrophobic particles partition to the surfactant rich phase but the migration may be slow. When hydrophobic magnetic particles are used in conjunction with a permanent magnet above the vessel, the migration is fast enough to be of practical use. Thus a unit operation consists of a stirred vessel connected to a flow-through decanting vessel. In the stirred vessel the desired action takes place: binding to or adsorption of a substance onto the magnetic particles; washing of magnetic particles with the substance; elution of substance from magnetic particles; regeneration of beads. In the flow-through decanting vessel the beads migrate to the surfactant rich phase and are separated from the rest of the solution which remains in the surfactant poor phase; the two phases are collected separately.

The invention can perform purifications similar to the other methods but it is structurally different from them. Crucially it is the only one enabling continuous counter-current moving bed chromatography.

### BIBLIOGRAPHY

1. Joseph Fedelem and Edwin J. Tuthill Apparatus for continuous chromatography, U.S. Pat. No. 3,527,350
2. Frank J. Healy and Paul R. Geissler Simulated moving bed adsorption-desorption process for para-xylene recovery, U.S. Pat. No. 4,029,717
3. Donald B. Broughton Process for separating normal and isoparaffins, U.S. Pat. No. 4,036,745
4. Hiroyuki Odawara, Masaji Ohno, Toni Yamazaki and Masazumi Kanaoka Continuous separation of fructose from a mixture of sugars, U.S. Pat. No. 4,157,267
5. Mark J. Gattuso Process for preparation of the pharmaceutically desired (S)-oxetine enantiomers, U.S. Pat. No. 5,889,186
6. Siu-Man Kelvin Lau, Diane Dong and Stephen Lu Purification of antibodies using simulated moving bed chromatography, US 20120122076
7. Konstantin Konstantinov, Rahul Godawat, Veena Warikoo and Sujit Jain Integrated Continuous Manufacturing of Therapeutic Protein Drug Substances, US 20140255994
8. Jeffrey Howard Siegell Continuous chromatographic separations in a magnetically stabilized fluidized bed, EP 0086068A2
9. Sanae Tabnaoui Magnetic fluidized bed for sample preconcentration and immunoextraction in microfluidic systems Analytical chemistry. Universite Pierre et Marie Curie—Paris VI, 2012
10. Sanae Tabnaoui, lago Pereiro, Marc Fremigier, Stephanie Descroix, Jean-Louis Viovy, Laurent Malaquin Magnetic fluidized bed in microfluidics: hydrodynamic characterization and validation to immunocapture 17^{th} International Conference on Miniaturised Systems for Chemistry and Life Sciences, October 2013, Freiburg, Germany
11. Brian A. Bolto, David R. Dixon, Everard A. Swinton and Donald E. Weiss Continuous ion exchange using magnetic shell resins. I Dealkalisation—Laboratory scale Journal of Chemical Technology and Biotechnology, 1979, volume 29, pp. 325-331
12. Nevil J. Anderson, David R. Dixon and Everard A. Swinton Continuous ion exchange using magnetic shell resins. II. Dealkalisation—Pilot plant study Journal of Chemical Technology and Biotechnology, 1979, volume 29, pp. 332-338
13. Lisa L. Evans and Mark A. Burns Countercurrent gradient chromatography: a continuous focusing technique Biotechnology and Bioengineering, 1995, volume 48, pp. 461-475
14. Karl Holschuh and Achim Schwammle Preparative purification of antibodies with protein A—An alternative to conventional chromatography Journal of Magnetism and Magnetic Materials, 2005, volume 293, pp. 345-348
15. P. Fraga Garcia, M. Brammen, M. Wolf, S. Reinlein, M. Freiherr von Roman and S. Berensmeier High-gradient magnetic separation for technical scale protein recovery using low cost magnetic nanoparticles Separation and Purification Technology, 2015, volume 150, pp. 29-36
16. Jurgen J. Hubbuch and Owen R. T. Thomas High-gradient magnetic affinity separation of trypsin from porcine pancreatin Biotechnology and Bioengineering, 2002, volume 79, pp. 301-3013
17. J. Lindner, K. Keller, G. Grim, J. Feller, C. F. Nielsen, N. Dalgaard. K. Menzel and H. Nirschl Magnetically Enhanced Centrifugation for industrial use In Upscaling of Bio-Nano Processes, Selective Bioseparation by magnetic particles Springer, Lecture Notes in Bioengineeering, 2014, pp. 131-146
18. K. Menzel, V. A. Amasifuen and H. Nirschl Design and performance or a pilot scale high-gradient magnetic filter using a mandhala magnet and its application for soy-whey protein purification In Upscaling of Bio-Nano Processes, Selective Bioseparation by magnetic particles Springer, Lecture Notes in Bioengineeering, 2014, pp. 147-174
19. A. Paulus and M. Franzreb Continuous Magnetic Extraction for protein purification In Upscaling of Bio-Nano Processes, Selective Bioseparation by magnetic particles Springer, Lecture Notes in Bioengineeering, 2014, pp. 175-186
20. Anja Paulus, Ingo Fischer, Timothy J. Hobley and Matthias Franzreb Use of Continuous Magnetic Extraction for removal of feedstock contaminants in flow-through mode Separation and Purification Technology, 2014, volume 127, pp. 174-180
21. I. Fischer, C C. Hsu, M. Gärtner, C. Müller, T. W. Overton, O. R. T. Thomas and M. Franzreb Continuous protein purification using functionalized magnetic nanoparticles in aqueous micellar two-phase systems Journal of Chromatography A, 2013, volume 1305, pp. 7-16

### Definitions

The term “fluid” refers to a gas or liquid flowing through the column or the vessel. It may consist of one or more phases. The term “flow of a fluid” refers to movement of a fluid in a single direction within the column or the vessel.

The term “bed” refers to solid materials used to fill a column or a vessel. The filling is such that the solid remains porous and allows the fluid to flow through.

The term “feed” refers to a fluid containing one or more substances which are to be separated.

The term “target substance” refers to one or more substances which are present in the feed and are to be separated from the feed. The “target substance” may be the desired substance or an undesired substance to be removed from the feed.

The term “buffer solution” refers to a fluid that does not react with the target substance or adsorb on the bed or disturbs the binding of the target substance with the bed.

The term “loading” refers to the capture of the “target substance” by the bed followed by the discharge of the remaining feed.

The term “elution” refers to the release of the “target substance” from the bed followed by the regeneration of the column.

### SUMMARY OF THE INVENTION

The invention relates to continuous chromatography and consists of an apparatus that creates a true moving bed column. The true moving bed column may be used for every step in chromatography: loading, washing, elution and regeneration. The bed consists of magnetic particles, the movement of which is induced and controlled using externally generated magnetic fields. A device located outside the column generates magnetic fields which can move the bed independently of the fluid. The fluid phase and the bed may move co-currently, counter-currently, perpendicularly or at any prescribed angle. The magnetic particles are coated with materials exhibiting the desired chromatographic behaviour. The magnetic field is generated by permanent magnets located outside the column. These magnets may be either static or mobile.

According to a first aspect of the invention, there is provided an apparatus as described in claim 1. Preferred embodiments of this are set out in claims 2 to 48.

According to another aspect of the invention, there is provided a method as described in claim 49. Preferred embodiments of this are set out in claims 50 to 61.

### DESCRIPTION OF THE FIGURES

FIGS. 1 to 10 have common graphical conventions. The magnets are shown in grey. The arrow on a magnet shows the direction of its magnetisation. The curly arrows indicate the direction of rotation for each set of magnets. Columns are depicted by hollow tubes whose walls are thick black lines. The dots in a column represent the magnetic particles that constitute the moving bed. In a column the arrow with a white head indicates the motion of the bed. The feed is delineated by the cross-hatched areas of columns. The black arrows in a column or at the end of a column indicate the motion of the fluid phase.

FIG. 1 is the general schema of counter-current moving bed chromatography.

FIG. 2 is the general schema of co-current moving bed chromatography.

FIG. 3A shows the top view of an apparatus with static magnets performing the loading of a counter-current moving bed with multiple cylindrical columns operating in parallel. FIG. 3B shows the cross-sectional view of one of the columns.

FIGS. 4A and 4B show the cross-sectional views of two apparatuses with static magnets performing the loading of a counter-current moving bed. The top view of these apparatuses is the same as the top view in FIG. 3.

FIG. 5A shows the cross-sectional view of an apparatus with mobile magnets performing the loading of a counter-current moving bed. FIG. 5B shows a cross-sectional view of the same apparatus across the diameter of the column. FIG. 5C shows a cross-sectional view of the same apparatus across the diameter of the column at a point where an aperture is inserted in the column.

FIG. 6A shows the top view of an apparatus with static magnets performing the loading of a bed moving at a specific angle to the direction of the flow of the fluid. FIG. 6B shows the cross-sectional view of the same apparatus along the length of the column. FIG. 6C shows the composition of the magnetic force and of the drag exerted by the motion of the fluid on a particle.

FIG. 7A shows the top view of an apparatus with static magnets performing the elution of several substances from a bed moving perpendicularly to the direction of the flow of the fluid.

FIG. 7B shows the cross-sectional view of the same apparatus along the length of the column.

FIG. 7C shows the composition of the magnetic force and of the drag exerted by the motion of the fluid on a particle.

FIGS. 8A-H show the main ways of introducing an aperture in a sequence of magnets that must remain synchronised with the magnets on the opposite side.

FIGS. 9A-D show the main ways of designing an aperture with or without a change in the diameter of the column.

FIGS. 10A-I show some initial states for apparatuses with permanent static magnets.

FIGS. 11 to 14 have common graphical conventions. Thick black arrows represent the movement of magnetic particles. White arrows represent the movement of the fluid phase.

FIGS. 11A-G show the symbols of continuous magnetic chromatography units. 11A and 11B show the symbols of co-current moving bed chromatography units. 11C and 11D show the symbols of chromatography units with the bed moving at a specific angle. 11E and 11F show the symbols of counter-current moving bed chromatography units. 11G and 11H show the symbols of cross-current moving bed chromatography units. 11I shows the symbol of a magnetically enhanced decanter. In the chromatography units depicted by 11A, 11C, 11E and 11G the magnetic particles remain in the same solution throughout. In the chromatography units depicted in 11B, 11D, 11F and 11H the magnetic particles transition from one solution to another.

FIG. 12 shows a flowchart of the overall process applied to one target substance, including the loading, washing, elution and regeneration steps.

FIG. 13 shows a flowchart of the overall process applied to three target substances, including the loading, washing, elution and regeneration steps.

FIG. 14 shows the flowchart of the overall process applied to one target substance, including the loading, washing, elution and regeneration steps with recycling of the imperfectly purified target substance.

### DESCRIPTION OF THE INVENTION

The invention relates to continuous chromatography that can be applied on industrial scale and includes an apparatus operating with a true moving bed column and a method of using the apparatus to perform continuous true moving bed chromatography. The components are described below.

### Particles

The bed may consist of independent particles. Each individual particle comprises two layers: the inner layer has magnetic properties; the outer layer consists of a material exhibiting the desired chromatographic behaviour. Optionally, each particle may also comprise at least one middle layer, which may insulate the inner layer and provide support for the outer layer. The middle layers may have additional roles deemed useful in a particular situation. The middle layers may not be necessary for every kind of particle.

The inner layer may be made of a material which exhibits macroscopic magnetic properties such as: ferromagnetism, ferrimagnetism, paramagnetism, superparamagnetism or diamagnetism. Ferromagnetic and ferrimagnetic materials are divided in two classes depending on their coercitivity: hard ferromagnetic and ferrimagnetic materials have high coercitivity whereas soft ferromagnetic materials have low coercitivity; the threshold is commonly taken to be 1000 A/m. Hard ferromagnetic and ferrimagnetic materials usually become permanent magnets once exposed to strong magnetic fields. Soft ferromagnetic and ferrimagnetic materials usually behave like paramagnetic materials when exposed to strong magnetic fields, and are considered superparamagnetic in these circumstances. All ferromagnetic and ferrimagnetic materials are superparamagnetic when their size is small enough, usually under 100 nm. Hence an inner layer may be made of a material which is either a permanent magnet or a magnet induced through paramagnetism, superparamagnetism or diamagnetism. In an embodiment where the inner layer is a permanent magnet, the inner layer may be made of neodymium-iron-boron alloys, samarium-cobalt alloys, iron-aluminium-nickel-cobalt alloys, cobalt, nickel, manganese-zinc ferrite, nickel-zinc ferrite or chromium dioxide. Preferably, in the embodiment where the inner layer is a permanent magnet, the inner layer is made of neodymium-iron-boron alloys or of chromium dioxide.

In an embodiment where the inner layer is paramagnetic or superparamagnetic, it may be made of magnetite, maghemite, silicon electrical steels, nickel-iron alloys, cobalt-iron alloys or metallic glasses. Preferably, in the embodiment where the inner layer is paramagnetic or superparamagnetic, the inner layer is made of magnetite.

In an embodiment where the inner layer is diamagnetic it may be made of bismuth, pyrolytic carbon or graphite. Preferably, in the embodiment where the inner layer is diamagnetic, the inner layer is made of pyrolytic carbon.

In another embodiment the inner layer may be made of a matrix with no magnetic properties, which encompasses the materials with magnetic properties. The matrix may be made of polystyrene, silica, poly-siloxane, poly-methylmethacrylate, poly-vinyl alcohol, poly-acrylamide, poly-vinyl butyral, or cellulose. In another embodiment the inner layer may be made of a core with no magnetic properties coated with small particles of material with magnetic properties. The core may be made of polystyrene or silica.

In another embodiment the inner layer may be made of the globular protein ferritin fully or partially loaded with ferric ions. In another embodiment the inner layer may be made of an aggregate or polymer of ferritins fully or partially loaded with ferric ions. The number of ferritin units in the aggregate or polymer may range from a few tens to a few billions depending on the desired size of the particle.

The outer layer is chosen according to the type of chromatography to be performed and any chromatography whose matrix is split into small fragments can be performed: generic, ion exchange, affinity, size exclusion, hydrophobic interaction, etc.

For example an outer layer made of silica or alumina enables generic chromatography. An outer layer made of a sulfonated polystyrene-divinylbenzene copolymer or of a methacrylic acid-divinylbenzene copolymer enables cation exchange chromatography. An outer layer made of aminated polystyrene-divinylbenzene copolymer enables anion exchange chromatography. An outer layer of protein A or protein G enables affinity chromatography for immunoglobulin G. An outer layer made of streptavidin enables affinity chromatography for biotin or biotin containing compounds. An outer layer made of macroporous cross-linked dextran or agarose enables size exclusion chromatography. An outer layer made of cross-linked poly-methylmethacrylate with phenyl or alkyl substitutions enables hydrophobic interaction chromatography. An outer layer made of hydroxylapatite enables a mixed-mode chromatography. In some embodiments one or more middle layers may be needed to insulate the inner layer or to provide support for the outer layer. Common materials for middle layers are silica, dextran and polystyrene. Other materials for middle layers include alumina, zirconium manganese ferrite, gold, silver, chitosan, poly-vinyl alcohol, poly-ethylimine, poly-methylmethacrylate, poly-vinylpyrrolidone and poly-siloxanes. Preferably inorganic middle layers are made of silica and organic middle layers are made of polystyrene or poly-methylmethacrylate.

The content of magnetic material in a particle varies between 10% and 90% of total volume. Preferably the content of magnetic material in a particle is at least 30% of the total volume. In general higher magnetic contents are preferable because the higher the magnetic content the better the manipulability of the particle with an external magnetic field. In some embodiments, the magnetic content of the particles is about 50% of the total volume. Furthermore the dispersion in magnetic content must remain small to ensure that their behaviour remains within the tolerance of the external magnetic field. In some embodiments, the particles have a relative magnetic permeability of at least 1.25 and a magnetisation at saturation of at least 3500 A/m.

The shape of particles may vary according to operational requirements: spheres, spheroids, ovoids, cylinders, fibres, petals, irregular forms or anything deemed useful in a particular situation. Preferably the particles are either spheroidal or cylindrical. In some embodiments, spheroidal particles may be used. Spheroidal particles are approximately isotropic hence they rotate easily and react approximately uniformly on their surface; they usually are the easiest to synthesize hence the cheapest. In some embodiments, cylindrical particles may be used. Cylindrical particles form small nematic phases when placed in an external magnetic field, which results in the smallest viscous drag for a given size while conserving a large contact surface.

The size of a particle is defined by the longest of its dimensions. The size of the particles may range from 10 nm to 1 cm. The size of the particles is determined by two competing requirements: the smaller the particle size, the higher the contact surface for a given volume of particles; the smaller the particle size, the lower the magnetic content hence the lesser the manipulability by an external magnetic field. In embodiments where the contact surface is sought to be as large as possible the size of particles is between 50 nm and 150 nm. In embodiments where the manipulability by an external magnetic field is important the size of particles is between 100 microns and 200 microns. In embodiments where the contact surface and the manipulability by an external magnetic field are balanced the size of particles is between 1 micron and 2 microns. In other embodiments the particles are spheroidal particles with a diameter between 1 micron and 100 microns, preferably between 5 microns and 75 microns, and more preferably between 10 microns and 50 microns. Furthermore, preferably the dispersion in the size of particles is small to ensure that their behaviour remains within the tolerance of the external magnetic field.

In another embodiment the bed may consist of a collection of distinct porous matrices with magnetic properties, every matrix spanning the whole diameter or thickness of the column. The extent of the matrix in the axial direction is determined by the requirements of a particular situation. Preferably the axial extent is not smaller than the diameter or the thickness of the column. Preferably the axial extent is close to the diameter or thickness of the column, or to the size of the magnets.

The matrix must be permeated by a continuous network of through pores in order to allow the flow of the fluid phase. The size distribution of the pores in the matrix is determined by the requirements of a particular situation. Preferably, the pore size is between 10 nm and 100 microns. Preferably the size of the pores in a matrix spans one or two orders of magnitude.

The matrix may be made of the same kind of independent magnetic particles as described above. The magnetic particles are cross-linked to form a magnetic matrix. Performing the cross-linking depends on the outer layer. If the outer layer is made of silica or alumina, the matrix can be fabricated by triggering a sol-gel transition. If the outer layer is polymeric, the matrix can be fabricated by restarting the polymerisation. If the outer layer bears specific functional groups, the matrix can be fabricated by mixing the functional groups with siloxane functions and triggering a sol-gel transition or by mixing them with polymerisation initiator groups and starting a short polymerisation.

The matrix may be made by fabricating a small non-magnetic monolith first then attaching magnetic particles to it. The matrix may also be made by embedding magnetic particles in a small non-magnetic monolith while it is being fabricated. In both cases the magnetic particles may be similar to the ones described above but consisting only of an inner layer and a middle layer. Preferably the middle layer of magnetic particles is of the same material as the backbone of the monolith. Common materials for the porous backbone include silica and copolymers of acrylamide, methylmethacrylate and glycidylmethacrylate. The non-magnetic monolith is made to exhibit the desired chromatographic behaviour: generic, ion exchange, affinity, hydrophobic interaction, reversed-phase, etc. The non-magnetic monolith is made in two general steps: first the fabrication of the porous backbone; second the addition of functional groups or affinity ligands onto the surface.

### Column

The column must be made of a material with a relative magnetic permeability between 0.95 and 1.05 so as not to interfere with the magnetic field imposed. Materials with magnetic permeability in the range 0.99 to 1.01 are preferable. Borosilicate glass is a suitable material when operating at pressures lower than 1 MPa to 5 MPa, depending on the grade. When operating at pressures higher than 1 MPa to 5 MPa, austenitic stainless steel alloys and titanium or titanium alloys are suitable materials. Plastic materials may be employed for single-use columns. Poly-methylmethacrylate and polycarbonates are suitable when operating at operating at pressures lower than 1 MPa. Poly-amideimide and nylons are suitable when operating at pressures up to 3 MPa. The column may also be a composite of a permanent external metallic layer and of a single-use internal plastic layer.

The relative magnetic permeability of components in the apparatus may be measured by conventional methods, for example using magnetoresistive magnetometers or Hall effect magnetometers.

The diameter or thickness of the column is heavily constrained by the magnetic properties of the particles used for the bed, and by the strength of the remanent magnetisation of the magnets. The wall of the column must be thin in order to position the magnets close to the lumen of the column. Moreover the wall of a column is supposed to be thin relative to its diameter or thickness. The column preferably has an inner diameter or thickness between 0.5 cm and 5 cm, more preferably 0.5 cm to 3 cm, more preferably 0.5 cm to 1.5 cm. The wall of the column is preferably 0.5 mm to 5 mm thick, more preferably 0.5 mm to 3.5 mm thick, more preferably 0.5 mm to 2 mm thick.

The shape of a column may vary according to operational requirements: in some embodiments the column comprises a cylindrical vessel; in other embodiments the column comprises multiple parallel cylindrical vessels; in other embodiments the column comprises a cuboid vessel with rounded corners; in other embodiments the column comprises multiple cuboid vessels with rounded corners; in some embodiments the column comprises a prismatic vessel; in other embodiments the column comprises multiple parallel prismatic vessels; or anything deemed useful in a particular situation. When multiple vessels are used, the number of vessels used is not particularly limited, but may be between 2 to 15, more preferably 5 to 15, or more preferably 8 to 12. Preferably the total width of the vessels in parallel is less than 60 cm and more preferably is between 10 cm and 30 cm. When multiple vessels are used, the distance between them may be between 0.25 mm to 5 mm, preferably 0.5 mm to 2 mm. The width of a cuboid vessel is preferably less than 5 times its thickness so as to obtain good cross-sectional mixing. The flow rate and the viscosity of the fluid are the main factors determining the shape of the column. Indeed the velocity is heavily constrained by the drag exerted on the magnetic particles therefore the shape is determined by the total cross-sectional area required to accommodate the required flow rate given the viscosity. Moving from a single cylinder to a cuboid with rounded corners then to a set of cylinders then to a set of cuboids with rounded corners increases the cross-sectional area of the column.

The length of the column and the positions of the inlet and outlet apertures are adapted to operational requirements. The main factor determining the total length and the distances between the apertures is the residence time required in each section of the column. It is preferable to have at least six magnets between two consecutive apertures, and to have at least four magnets between an aperture and an end of the column. In some embodiments, the length of the column will be between 50 cm and 2 m, preferably 75 cm to 1.5 m, preferably 1 m to 1.5 m and in some embodiments about 130 cm. The column may have at least one aperture, in some instances at least two apertures, and in further instances at least three apertures. Preferably, apertures are positioned at least 10 cm away from an end of the column or vessel. Preferably, an aperture is positioned at a distance of at least 5 times the inner diameter or thickness of the vessel and at most at a distance of 15 times the inner diameter or thickness of the vessel from another aperture. In some embodiments, apertures are positioned at least 15 cm from each other. The apertures may be any shape, including rectangular and cylindrical. Preferably, the inner diameter or thickness of the apertures is less than half the inner diameter or thickness of the column. In some embodiments, the apertures are cylindrical and the inner diameter of an aperture may be between 0.1 cm and 2.5 cm, preferably between 0.2 cm and 2 cm, preferably between 0.3 cm and 1.5 cm, and more preferably between 0.4 cm and 1 cm.

The fluid flows through the column under a pressure gradient. The bed is moved by magnetic fields generated by magnets located outside the column. The fluid and the bed may move co-currently, counter-currently, perpendicularly or at any prescribed angle. The preferred way of operating a column is with counter-current flow.

### Magnets

A device generating strong magnetic fields is provided outside the column in order to control the flow of particles through the column. The device generates magnetic fields which can move the bed independently of the fluid. Typically, this device consists of a plurality of magnets. The magnetic fields generated externally are non-uniform, spatially varying, typically exhibiting strong spatial gradients because the magnetic force exerted on magnetic particles usually increases with increasing magnetic field spatial gradient. The magnetic fields generated externally are time varying, typically evolving so as to displace the zones with strong magnetic field gradients in a continuous fashion, i.e. the zones move progressively from one position to another, and contiguous fashion, i.e. one zone does not disappear in one place and appear in another. The magnetic particles generally congregate in the zones with strong magnetic field gradients because in these zones the magnetic force exceeds the drag generated by the flow of the fluid. Hence the magnetic particles move through the column as a result of the movement of the zones of strong magnetic field gradients.

In some embodiments a set of independently controlled electromagnets are positioned in the vicinity of the column. The electromagnets may be air cooled or water cooled electromagnets with cores made of powdered iron, manganese-zinc ferrite, nickel-zinc ferrite, laminated silicon steels or any other materials with low eddy current loss and low hysteresis loss. The electromagnets may also be liquid nitrogen cooled or helium cooled superconductors. The water cooled electromagnets are preferable when the intensity of the magnetic field is lower than 1.5 Tesla and helium cooled superconductors are preferable when the intensity of the magnetic field is higher than 1.5 Tesla.

In other embodiments the magnets are permanent. The magnets may be either static or mobile. Their shape may vary according to operational requirements: cylinder, hollow cylinder, rectangular cuboid, horizontal segment of a hollow cylinder or anything deemed useful in a particular geometry. The direction of the remanent magnetisation within a magnet depends on the configuration used: axial, radial, one directional perpendicular to an axis of the magnet or anything deemed useful in a particular geometry. The configuration of magnets can be adapted to operational requirements: on one side of the column, on opposite sides of the column, all around the column or in any set of positions deemed useful in a particular geometry. The magnets must span the whole operational length of the column. Preferably, the magnets extend beyond the edge of a column on each side by a length corresponding to the diameter or thickness of the column. Preferably magnets are positioned in layers. Preferably, one or two layers of magnets are placed on each side of the column.

Strong magnets are preferred as they allow more flexibility in the design of a particular configuration. Strong magnets have high remanent magnetisation, high coercitivity and high maximum energy product. The materials preferred for strong magnets are neodymium-iron-boron alloys, samarium-cobalt alloys and iron-aluminium-nickel-cobalt alloys. More preferably the strong magnets are made of neodymium-iron-boron alloys. Preferably, the magnetic remanence of the magnets is at least 1.20 T, preferably at least 1.25 T. Preferably, the magnets have a protective coating. For instance, a three layer Ni—Cu—Ni coating may be used on neodymium-iron-boron magnets. Preferably, the thickness of the protective coating is at least 15 μm.

### Static Magnets

When static magnets are used, the magnets are preferably cylindrical, and may have a diameter between a fifth and five times the diameter or thickness of the column, preferably between half and twice the diameter or thickness of the column. In some embodiments the magnets have a diameter between 0.2 cm and 5 cm, preferably between 0.5 cm and 4 cm, preferably between 0.5 cm and 2.5 cm, more preferably between 0.8 cm and 1.5 cm. Alternatively, in other embodiments the diameter of the cylindrical magnets is between 1 cm and 2 cm. The spacing between the magnets may be between 0.1 mm and 1 cm, preferably between 0.3 mm and 5 mm, preferably between 0.5 and 5 mm, or between 0.5 mm and 2 mm or 1 mm and 2 mm. The static magnets may be attached to a fixed device which can rotate them about their longitudinal axis. Preferably, this device is non-magnetic. The magnets may be positioned so as to create alternating zones of high and low magnetic field intensity along the axis of the column, which may result in alternating zones of strong and weak magnetic field gradients along the axis of the column. The rotation of the magnets about their longitudinal axis causes the zones of strong magnetic field gradients to move and distort, which in turn induces and controls the movement of the bed. The angular velocity profile of the magnets is adapted to a particular situation. The inside of the column experiences a non-uniform magnetic field.

In one embodiment, magnets are used to induce the flow of particles in a direction opposite to the flow of feed solution. Preferably, static permanent magnets are provided around the column. Preferably the column is made of a cylindrical vessel with first, second and third apertures. Preferably, the length of the column is between 75 cm to 1.5 m, preferably 1 m to 1.5 m, preferably about 130 cm. Preferably, the column is made of austenitic stainless steel, and the walls of the column may be 0.5 mm to 5 mm thick, more preferably 0.5 mm to 3.5 mm thick, more preferably 0.5 mm to 2 mm thick. The column preferably has an inner diameter between 0.5 cm and 5 cm, more preferably 0.5 cm to 3 cm, more preferably 0.5 cm to 1.5 cm. Preferably, apertures are positioned at least 10 cm away from the ends of the column. Preferably, an aperture is positioned at least 10 cm and at most 20 cm from any other aperture. Preferably, the apertures are cylindrical. Preferably, the inner diameter of the apertures is less than half the inner diameter of the column. Preferably, two sets of cylindrical magnets are positioned on opposite sides of the column and the magnetisation of each magnet is in a direction perpendicular to the longitudinal axis of the magnet, and the longitudinal axis of each magnet is perpendicular to the longitudinal axis of the column. In some embodiments, two layers of magnets may be provided on each side of the column. Preferably, there are at least six magnets between two consecutive apertures, and at least four magnets between an aperture and an end of the column. Preferably, the magnets are formed of a neodymium-iron-boron alloy and may have an additional protective coating. The magnets may have a diameter between 0.2 cm and 10 cm, preferably between 0.5 cm and 5 cm, preferably between 0.5 cm and 2.5 cm, more preferably between 0.8 cm and 1.5 cm and may extend beyond the edge of a column on each side by a length corresponding to the diameter of the column. The spacing between the magnets may be between 0.1 mm and 1 cm, preferably between 0.5 mm and 5 mm, more preferably between 1 mm and 2 mm. In use, a buffer solution enters the column through the first aperture and flows in both first and second directions along the column. A feed solution containing a target substance enters the column through the second aperture and flows in the first direction along the column, towards a second end of the column. A solution containing the particles enters the column through the third aperture and the particles are moved by the magnets in the second direction, opposite to the flow of the feed solution, towards a first end of the column. The feed solution without the target substance flows out of the second end of the column. The particles with the target substance bound flow out of the first end of the column.

In another embodiment magnets are used to control the flow of particles in the same direction as the flow of the feed solution (co-current mode). The magnetic particles may move faster or more slowly than the feed mixture, or at the same speed. Preferably, static permanent magnets are provided around the column. Preferably the column is made of a cylindrical vessel with first, second and third apertures. Preferably, two sets of cylindrical magnets are positioned on opposite sides of the column and the magnetisation of each magnet is in a direction perpendicular to the longitudinal axis of the magnet, and the longitudinal axis of each magnet is perpendicular to the longitudinal axis of the column. In some embodiments, two layers of magnets may be provided on each side of the column. In use, a feed solution containing a target substance enters the column through a first end and flows in a first direction along the column. A solution containing the particles enters the column through the first aperture and flows in the first direction along the column, mixing with the feed solution. The target substance attaches onto the magnetic particles as they move in the first direction until they reach the second aperture. A buffer solution enters the column through the third aperture. Part of the buffer solution flows in the first direction and part of the buffer solution flows in a second direction, opposite to the first direction, under two diverging pressure gradients. At the level of the second aperture the feed mixture is depleted of the target substance and runs into the buffer solution flowing in the second direction. The feed mixture and the buffer solution mix and flow out of the column through the second aperture. At the second aperture a magnetic field may prevent the magnetic particles from flowing out of the column. Alternatively a filter preventing the outflow of the particles may be provided at the second aperture to supplement or replace the magnetic field. Thus, the magnetic particles with the target substance attached to them remain in the column and flow in the first direction, first against then in the same direction as the buffer solution. Once the magnetic particles reach the opening at a second end of the column they are carried away by the buffer solution.

In another embodiment the column of the apparatus comprises multiple parallel vessels. The vessels and magnets may be set up and operate as described in any of the embodiments. Preferably, the vessels are cylindrical. Preferably, the vessels all have the same diameter. Preferably, the magnets extend across the width of the whole set of vessels so that a single set of magnets can be used to induce and control the movement of particles in every vessel simultaneously, thus enabling the parallel use of all vessels. Preferably, the magnets extend beyond the edge of the column on each side by a length corresponding to the diameter of a vessel.

In another embodiment static magnets are used to induce and control the flow of particles at an angle relative to the flow of the feed solution. The particles may move in a direction that is perpendicular to the flow of the feed solution. Preferably, in this embodiment, the column is a cuboid vessel with first and second ends, first and second sides and a top and a bottom face. Preferably the length of the vessel, measured from the first end to the second end, is between 0.3 m and 1.5 m, preferably 0.75 m and 1.25 m, more preferably around 1 m. The width of the vessel, measured from the first side to the second side, may be between one tenth and one times the length of the vessel, preferably between one fifth and three quarters of the length of the vessel, more preferably between one quarter and one half of the length of the vessel. In some embodiments the width of the vessel may be between 10 cm and 100 cm, preferably between 20 cm and 75 cm, preferably between 25 cm and 50 cm, and more preferably about 35 cm. The inner thickness of the vessel, measured between the top and bottom faces, may be between 0.5 cm and 5 cm, preferably 0.6 cm and 3.5 cm, more preferably between 0.8 cm and 1.5 cm. The walls of the column are preferably made of austenitic stainless steel and may have a thickness between 0.5 mm to 5 mm, more preferably 0.5 mm to 3.5 mm, more preferably 0.5 mm to 2 mm. Preferably, the column has a first aperture on the first side near the first end and a second aperture on the second side near the second end. Preferably, the first aperture is perpendicular to the first side of the column and the second aperture joins the column in a direction parallel to the second side of the column. The first aperture may be circular with a diameter equivalent to the inner thickness of the column. Preferably, the first aperture is positioned on the first side of the column at least 2 cm and at most 6 cm from the first end. The second aperture may be accommodated in this orientation by making the distance between the first and second sides wider towards the second end of the column where the second aperture joins, preferably by an amount corresponding to the width of the second aperture, thus creating a kink in the second side of the column. Preferably, the second aperture is rectangular and has an inner height corresponding to the thickness of the column. Preferably, the inner width of the second aperture is between 2 cm and 5 cm. Preferably, the thickness of the wall of the second aperture is the same as the thickness of the wall of the column. Preferably, the second aperture is positioned between 4 and 6 cm from the second end. Preferably, the first end of the column is an inlet. Preferably the second end of the column is divided in two contiguous outlets of different sizes: a larger outlet towards the first side and a smaller outlet towards the second side. Preferably, the dividing wall between the two outlets has the same thickness as the wall of the column. Preferably, the larger outlet is between 32 cm and 34 cm wide. Preferably, the magnets are positioned above and below the column, at a specific angle to the longitudinal axis of the column such that the first end of each magnet positioned over the first side of the column is closer to the first end of the column than the second end of each magnet positioned over the second side of the column, so that when viewed from the top, the magnets are positioned at an angle across the width of the column. Preferably, the magnets are cylindrical and their magnetisation is in a direction perpendicular to the longitudinal axis of the magnets. Preferably, the magnets are formed of a neodymium-iron-boron alloy and may have an additional protective coating. Preferably, the magnets are cylindrical and have a diameter between 1 cm and 2 cm. Preferably the magnets are between 35 cm and 55 cm long, more preferably around 40 cm long. The spacing between the magnets may be between 1 mm and 1 cm, preferably between 1 mm and 5 mm, more preferably between 1 mm and 2 mm. Preferably, the magnets extend beyond the edge of the column on each side by a length corresponding to the thickness of the column. Preferably, two layers of magnets are present above and below the column. In use, the set of magnets on one side of the column rotate in the opposite direction to the set of magnets on the other side of the column, both sets of magnets rotating at a uniform velocity. Preferably, the magnets rotate with an angular velocity between 0.01 rad/s to 10.0 rad/s or from 0.01 rad/s to 1 rad/s. The feed solution containing the target substance enters the column through the first end of the column and flows in a first direction under a pressure gradient from the first end of the column towards the second end of the column. The magnetic particles enter the column through the first aperture carried by a buffer solution. As the feed solution moves along the length of the column in the first direction, the magnetic particles move along a diagonal path from the first side of the column to the second side of the column under the combined force resulting from the magnetic force and the viscous drag induced by the motion of the fluid in the first direction. As the magnetic particles move through the feed solution, the target substance binds to them. The magnetic particles with the target substance attached to them reach the second side of the column then flow in the first direction until they reach the second aperture. A buffer solution enters the column through the second aperture and flows out of the column through both outlets of the second end of the column. The buffer solution pushes the feed solution away from the smaller outlet by introducing a slight pressure gradient in the fluid phase towards the first side of the column. The magnetic particles move into the kink on the second side of the column then are carried out of the column by the buffer solution through the smaller outlet. The feed solution depleted of the target substance flows out of the column through the larger outlet.

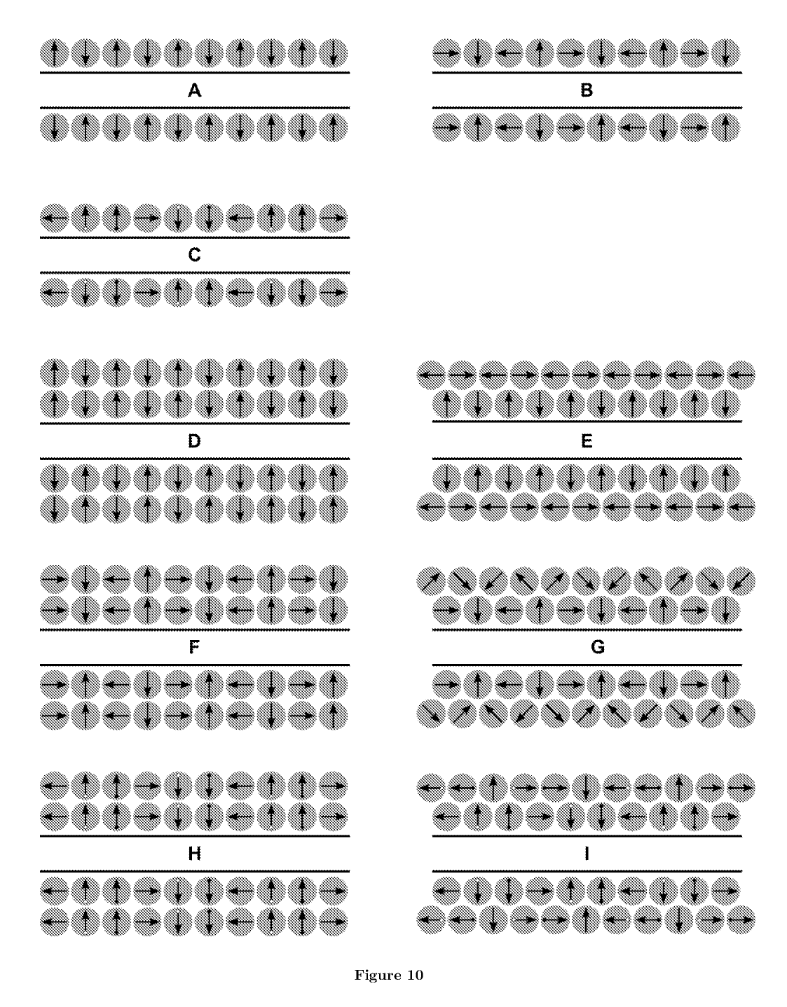

For the embodiments where static magnets are used the magnets are preferably positioned on opposite sides of the column arranged in one or two layers on each side, with their magnetisation in a direction perpendicular to the longitudinal axis of the magnets. Possible embodiments of the initial states of the magnets are shown in FIGS. 10A-I.

In FIGS. 10A, 10D and 10E the magnetisations within a layer are in an alternating sequence. In FIG. 10A, a single layer of static magnets is shown on each side of the column. The initial direction of magnetisation for the magnets is perpendicular to the longitudinal axis of the column, either pointing inwards towards the column or outwards away from the column. The alternating sequence of magnets is matched across the diameter of the column, such that when one magnet has a direction of magnetisation pointing inwards towards the column, the magnet opposite also has a direction of magnetisation pointing inwards towards the column. Conversely, when one magnet has a direction of magnetisation pointing outwards away from the column, the magnet opposite also has a direction of magnetisation pointing outwards away from the column. This may be duplicated across two layers of magnets as shown in FIG. 10D. FIG. 10E also shows the initial direction of magnetisation for two layers of magnets on opposite sides of the column. In this arrangement the inner layer of magnets on each side closest to the column is arranged as in FIG. 10A. In the outer layer, the direction of magnetisation alternates between two opposing directions parallel to the longitudinal axis of the column. The alternating sequence of magnets is matched across the diameter of the column such that the directions of magnetisations of the magnets on one side are the mirror images of the directions of magnetisation of the magnets on the other side of the column.

In FIGS. 10B, 10F and 10G the directions of magnetisation for the magnets within a layer are in a sequence corresponding to a Halbach array. FIG. 10B shows a single layer of magnets on each side of the column with their initial directions of magnetisation forming a Halbach array. FIG. 10F shows a similar arrangement to FIG. 10B with two layers of magnets on opposite sides of the column. FIG. 10G also has two layers of magnets on opposite sides of the column, but with the initial directions of magnetisation of the magnets in the outer layers offset by 45° relative to the initial directions of magnetisation of the magnets in the inner layers. For all three embodiments, the directions of magnetisations of the magnets on one side are the mirror image of the directions of magnetisation of the magnets on the other side of the column.

For the embodiments with initial states shown in FIGS. 10A-B and 10D-G, the magnets on opposite sides of the column may rotate in opposite directions with the same uniform angular velocity. In some embodiments, the magnets rotate at a constant angular velocity of between 1 and 10 rad/s, preferably 2 to 8 rad/s. In other embodiments, the magnets rotate at a constant angular velocity of between 0.005 and 5 rad/s, preferably between 0.005 and 1 rad/s, preferably 0.01 and 1 rad/s, more preferably 0.01 and 0.5 rad/s or between 0.01 and 0.2 rad/s.

FIGS. 10C, 10H and 10I show the initial position of the magnets according to another embodiment. FIG. 10C shows a column with a single layer of magnets on each side of the column whilst FIGS. 10H and 10I show a column with two layers of magnets on opposite sides of the column. In FIG. 10H the second outer layer of magnets is positioned level with the first inner layer, whereas in FIG. 10I the second outer layer of magnets is staggered relative to the first inner layer. For the embodiments with initial states shown in FIGS. 10C, 10H and 10I, the magnets on opposite sides of the column may rotate in opposite directions with the same angular profile given in the next paragraph.

The magnets are divided in multiple groups represented by the different starting points of the arrow representing their direction of magnetisation. Preferably, each magnet in an initial position has its direction of magnetisation in one of four possible directions separated by an angle of π/2. In a given layer, as shown in FIGS. 10C, 10H and 10I, in the initial sequence of the magnets, the magnets arranged are in blocks of six, where, relative to a first magnet, the second and third magnets are rotated by an angle of π/2, the fourth magnet is rotated by an angle of π, and the fifth and sixth magnets are rotated by an angle of 3π/2. The sequence then repeats. The magnets in each group have the same angle of rotation θ. For all three embodiments shown in FIGS. 10C, 10H and 10I, the directions of magnetisations of the magnets on one side are the mirror image of the directions of magnetisation of the magnets on the other side of the column. The rotation of the initial arrangements of magnets in the preceding paragraph is described depending on the starting position of the magnet. n is an integer indicating the position of magnet in its layer. n is increasing in the direction of the flow of magnetic particles. The origin n=0 is set on any magnet such that the magnetisation of the magnet in the position n−1 is in the same direction and that magnetisation of the magnet in position n+1 is in another direction. For the first rotation of π/2, for the magnets in a layer, every third magnet defined by a position (x) of x=3n, where n is an integer, remains stationary, whilst the other magnets rotate by an angle of π/2. For the second rotation of π/2, every third magnet in the layer defined by a position of x=3n+1 remains stationary, whilst the other magnets rotate by a further angle of π/2. For the third rotation of π/2, every third magnet in the layer defined by a position of x=3n+2 remains stationary, whilst the other magnets rotate by a further angle of π/2. During this process, the direction of magnetisation for each magnet is never rotated more than π/2 from the two magnets adjacent to it in a layer. In embodiments where one or more layers are present on opposite sides of the column, the layers on one side of the column rotate in the opposite direction to those on the other side. More generally, the rotation of the initial arrangements of magnets in the preceding paragraph is described using an auxiliary profile p, wherein:

t is the time measured from the start of the rotation of the magnets;

ν is a constant angular velocity expressed in radians per second;

T is a time constant associated to ν through

$$T = \frac{π}{2 v}$$

$$k = ⌊ \frac{t}{T} ⌋$$

$$p ( t ) = \vert \begin{matrix}0 & if k ≡ 0 [ 3 ] \\ v ( t - k \cdot T ) & if k ≡ 1 [ 3 ] \\ v ( t - ( k - 1 ) \cdot T ) & if k ≡ 2 [ 3 ]\end{matrix}$$

| Group by position in layer | Angle of Rotation - Auxiliary profile |
|---|---|
| Magnets in position x = 3n | θ(t) = p(t) |
| Magnets in position x = 3n + 1 | θ(t) = p(t + 2T) |
| Magnets in position x = 3n + 2 | θ(t) = p(t + T) |

### Mobile Magnets

In the embodiments where mobile permanent magnets are used, preferably the magnets are attached to a fixed support. The magnets are arranged such that the inside of column experiences a non-uniform magnetic field. Preferably the magnets are set in a configuration which results in alternating zones of high and low magnetic field intensity along the axis of the column and in alternating zones of strong and weak magnetic field gradients along the axis of the column. A dedicated device moves the support and the magnets. Preferably, the support and the magnets are translated along the axis of the column. The motion of the magnets induces the movement of the zones of strong magnetic field gradients, which in turn induces and controls the movement of the bed. The translational velocity profile of the magnets is adapted to the particular situation. The magnets may be attached to chains which run along the column. Each chain can form a closed loop which is held and moved by a mechanism. The chains and the mechanism are preferably made of non-magnetic materials. In some embodiments, two or more chains with magnets are positioned around the column in order to surround the column with the magnets. Preferably, the chains move the magnets along the column at constant velocity. Preferably, the magnets on each chain move at the same velocity in order to preserve the alignment across the column. When an apparatus using mobile magnets is used and an aperture interrupts the path of one of the chains, the chain with a path interrupted by the aperture may be split in to two separate chains to accommodate the aperture.

When mobile permanent magnets are used, the magnets are preferably cuboid. The length and width of the magnets are defined in a plane parallel to the mid-plane of the column and the height is defined as perpendicular to the length and the width. The magnets may have a width between a fifth and five times the diameter or thickness of the column, preferably between half and twice the diameter or thickness of the column. They may have a height between one half and five times their width, preferably between one and two three times their width.

Alternatively when mobile magnets are used and the column is cylindrical, the mobile magnets are preferably horizontal segments of a hollow cylinder. They may have an inner radius larger than the outer radius of the column by 0.5 mm to 5 mm, preferably by 1 mm to 2 mm. They may have an outer radius equal to the inner radius plus one half to five times the radius of the column, preferably equal to the inner radius plus one to three times the radius of the column. They may have a width between a fifth to five times the diameter of the column, preferably between half and twice the diameter of the column.

In an embodiment mobile magnets are employed to induce the flow of the particles in a direction opposite to the flow of the feed solution. Preferably, the column is made of a cylindrical vessel with three apertures. Preferably, the magnets are attached to a mobile support which enables translational motions. Preferably, the magnets are moved in a direction parallel to the longitudinal axis of the column. The magnets may be provided on one side of the column, or on opposite sides of the column, or may gird an arbitrary cross-sectional sector of the column. Preferably, the magnets gird the whole cross-section of the column and they may have the form of a quarter of a hollow cylinder with an inner diameter slightly larger than the outer diameter of the column, such that four magnets can be positioned to surround the circumference of the column. Preferably, the magnets are identical except for the direction of their magnetisation. Each set of four magnets that surround the circumference of the column are aligned and move at the same velocity. The magnetisation of each set of four magnets has the same direction: outwardly radial or inwardly radial relative to the column; or in a direction parallel to the longitudinal axis of the column in the first direction or in the second direction. In use, a buffer solution enters the column through the first aperture and flows in both first and second directions along the column. A feed solution containing a target substance enters the column through the second aperture and flows in the first direction along the column, towards the second end of the column. A solution containing the particles enters the column through the third aperture and the particles are moved by the magnets in the second direction, opposite to the flow of feed solution, towards the first end of the column. The feed solution without the target substance flows out of the second end of the column. Particles with the target substance bound flow out of the first end of the column.

In another embodiment mobile permanent magnets are used to induce and control the flow of particles at an angle relative to the flow of the feed solution. Preferably, in this embodiment, the column is a cuboid vessel with first and second ends, first and second sides and a top and a bottom face. Preferably the length of the vessel, measured from the first end to the second end, is between 0.3 m and 1.5 m, preferably 0.75 m and 1.25 m, more preferably around 1 m. The width of the vessel, measured from the first side to the second side, may be between one tenth and one times the length of the vessel, preferably between one fifth and three quarters of the length of the vessel, more preferably between one quarter and one half of the length of the vessel. In some embodiments the width of the vessel may be between 10 cm and 100 cm, preferably between 20 cm and 75 cm, preferably between 25 cm and 50 cm, and more preferably about 35 cm. The inner thickness of the vessel, measured between the top and bottom faces, may be between 0.5 cm and 5 cm, preferably 0.6 cm and 3.5 cm, more preferably between 0.8 cm and 1.5 cm. The walls of the column are preferably made of austenitic stainless steel and may have a thickness between 0.5 mm to 5 mm, more preferably 0.5 mm to 3.5 mm, more preferably 0.5 mm to 2 mm. Preferably, the column has a first aperture on the first side near the first end and a second aperture on the second side near the second end. Preferably, the first aperture is perpendicular to the first side of the column and the second aperture joins the column in a direction parallel to the second side of the column. The first aperture may be circular with a diameter equivalent to the inner thickness of the column. Preferably, the first aperture is positioned on the first side of the column at least 2 cm and at most 6 cm from the first end. The second aperture may be accommodated in this orientation by making the distance between the first and second sides wider towards the second end of the column where the second aperture joins, preferably by an amount corresponding to the width of the second aperture, thus creating a kink in the second side of the column. Preferably, the second aperture is rectangular and has an inner height corresponding to the thickness of the column. Preferably, the inner width of the second aperture is between 2 cm and 5 cm. Preferably, the thickness of the wall of the second aperture is the same as the thickness of the wall of the column. Preferably, the second aperture is positioned between 4 cm and 6 cm from the second end. Preferably, the first end of the column is an inlet. Preferably the second end of the column is divided in two contiguous outlets of different sizes: a larger outlet towards the first side and a smaller outlet towards the second side. Preferably, the dividing wall between the two outlets has the same thickness as the wall of the column. Preferably, the larger outlet is between 32 cm and 34 cm wide. Preferably, the magnets are the magnets are attached to a mobile support which enables translational motions. Preferably the magnets are positioned above and below the column, at a specific angle to the longitudinal axis of the column such that the first end of each magnet positioned over the first side of the column is closer to the first end of the column than the second end of each magnet positioned over the second side of the column, so that when viewed from the top, the magnets are positioned at an angle across the width of the column. Preferably, the magnets are formed of a neodymium-iron-boron alloy and may have an additional protective coating. Preferably, the magnets are cuboid. Preferably the magnets are between 35 cm and 55 cm long, more preferably around 40 cm long. Preferably the magnets are between 0.5 cm and 3 cm wide and more preferably between 1 cm and 2 cm wide. Preferably the magnets are between 1 cm and 6 cm high, more preferably between 3 cm and 5 cm high. The spacing between the magnets may be between 0.5 mm and 1 cm, preferably between 1 mm and 5 mm, more preferably between 1 mm and 2 mm. Preferably, the magnets extend beyond the edge of the column on each side by a length corresponding to the thickness of the column. In use, the mobile support above the column and the mobile support below the column move with the same uniform velocity. Preferably, the velocity is between 5·10⁻⁵ m/s and 5·10⁻³ m/s. The feed solution containing the target substance enters the column through the first end of the column and flows in a first direction under a pressure gradient from the first end of the column towards the second end of the column. The magnetic particles enter the column through the first aperture carried by a buffer solution. As the feed solution moves along the length of the column in the first direction, the magnetic particles move along a diagonal path from the first side of the column to the second side of the column under the combined force resulting from the magnetic force and the viscous drag induced by the motion of the fluid in the first direction. As the magnetic particles move through the feed solution, the target substance binds to them. The magnetic particles with the target substance attached to them reach the second side of the column then flow in the first direction until they reach the second aperture. A buffer solution enters the column through the second aperture and flows out of the column through both outlets of the second end of the column. The buffer solution pushes the feed solution away from the smaller outlet by introducing a slight pressure gradient in the fluid phase towards the first side of the column. The magnetic particles move into the kink on the second side of the column then are carried out of the column by the buffer solution through the smaller outlet. The feed solution depleted of the target substance flows out of the column through the larger outlet.

In the above embodiments describing the use of mobile magnets, the sequence of magnets attached to a support may form an alternating array, or a Halbach array, or a sequence in which the rotation of the initial arrangements of magnets in the preceding paragraph is described depending on the starting position of the magnet. n is an integer indicating the position of magnet in its layer. n is increasing in the direction of the flow of magnetic particles. The origin n=0 is set on any magnet such that the magnetisation of the magnet in the position n−1 is in the same direction and that magnetisation of the magnet in position n+1 is in another direction. For the first rotation of π/2, for the magnets in a layer, every third magnet defined by a position (x) of x=3n, where n is an integer, remains stationary, whilst the other magnets rotate by an angle of π/2. For the second rotation of π/2, every third magnet in the layer defined by a position of x=3n+1 remains stationary, whilst the other magnets rotate by a further angle of π/2. For the third rotation of π/2, every third magnet in the layer defined by a position of x=3n+2 remains stationary, whilst the other magnets rotate by a further angle of π/2. During this process, the direction of magnetisation for each magnet is never rotated more than π/2 from the two magnets adjacent to it in a layer. In embodiments where one or more layers are present on opposite sides of the column, the layers on one side of the column rotate in the opposite direction to those on the other side. More generally, the rotation of the initial arrangements of magnets in the preceding paragraph is described using an auxiliary profile p discussed above.

### Other Features of the Arrangement of Magnets

In the embodiments with either static or mobile magnets, the preferred configurations make use of magnets on at least two opposite sides of the column because the magnetic field and the gradient of the magnetic field can be enhanced by the use of more magnets in the same space. In these preferred configurations the magnets are identical in size and the magnets on either side are in a prescribed sequence and must remain aligned throughout the operation.

In the embodiments where the static or mobile magnets are used to induce and control the flow of particles at an angle relative to the flow of the feed solution, the angle between the longitudinal axis of the magnets and the longitudinal axis of the column is a design parameter. When the angle is ±90°, the magnets are at an angle perpendicular to the longitudinal axis of the column, pointing between the first and second sides of the column. When the angle is 0° the magnets lie parallel to the longitudinal axis of the column, pointing between the first and second ends. At this angle, the magnetic force is only used to push the magnetic particles towards the second side of the column. When the angle is between 0° and 90°, the magnets are rotated such that the ends of the magnets nearest the first side of the column are nearer the first end of the column than the ends of the magnets nearest the second side of the column. When the magnets are positioned between 0° and 90°, the magnetic force both pushes the magnetic particles towards the second side of the column and slows down their motion towards the second end of the column. When the angle is between −90° and 0°, the magnets are rotated such that the ends of the magnets nearest the first side of the column are nearer the second end of the column than the ends of the magnets nearest the second side of the column. When the magnets are positioned between 0° and −90°, the magnetic force both pushes the magnetic particles towards the second side of the column and hastens their motion towards the second end of the column. Thus the angle and the angular or linear velocity of the magnets may be used to both reduce the loss of particles through the larger outlet and to control the residence time in the column. Preferably, the angle between the longitudinal axis of the magnets and the longitudinal axis of the column is between 0° to 90°, more preferably between 10° and 45°, more preferably around 30°. In some embodiments, the device to which the static magnets are attached permits the angle between the magnets and the column to be adjusted. In other embodiments the support to which the mobile magnets are attached permits the angle between the magnets and the column to be adjusted.

In some embodiments the component of the magnetic force perpendicular to the longitudinal axis of the column may induce the magnetic particles to accumulate close to the wall of the column and to deplete the centre of the column. In the embodiments with permanent magnets on opposite sides of the column, the phenomenon may be diminished or reversed by shifting the magnets on one side with respect to the opposite side in the direction parallel to the longitudinal axis of the column or in the direction of translation of the mobile magnets. The size of the shift required increases with the strength of the component of the magnetic force perpendicular to the longitudinal axis of the column. Preferably the shift is a fraction of the diameter or size of the magnets. More preferably the shift is between one quarter and one times the diameter or size of the magnets.

In the above embodiments, the inlet and outlet apertures may be perpendicular to the column or may be positioned at an arbitrary angle to the column that is deemed useful in a particular geometry. Individual apertures may either allow or disallow the magnetic particles to move through them. The outlet apertures that disallow the passage of magnetic particles may be protected by a filter whose pore size is smaller than the size of the magnetic particles. Alternatively, the outlet apertures may rely on the arrangement of magnets to repel the magnetic particles from the opening. The inlet apertures that disallow the passage of magnetic particles through them may rely on the flow of fluid to keep them out or may be protected by a filter whose pore size is smaller than the size of magnetic particles.

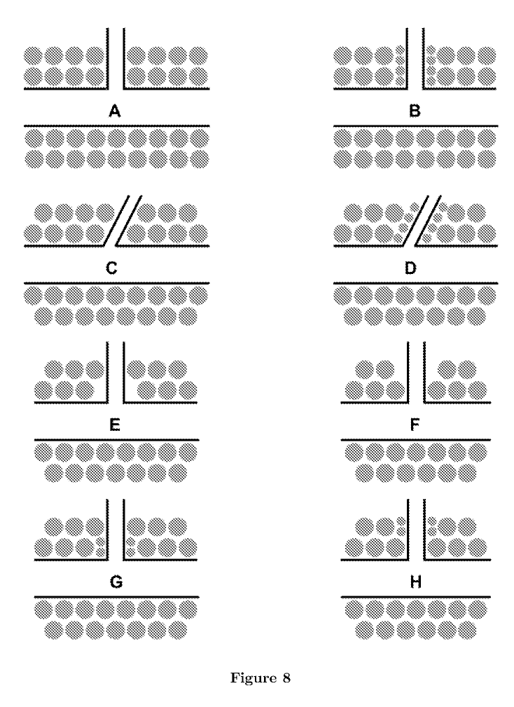

When static magnets are used in the above embodiments, the apertures disturb the arrangement of magnets. The apertures may be inserted in the sequence of magnets in four preferred ways. In all four preferred ways the diameter or the width of the aperture must be smaller than the diameter or the width of the magnets. (1) The aperture replaces exactly one magnet per magnet layer. This is illustrated by the configurations A and C in FIG. 8. (2) The aperture is inserted between exactly two magnets on each magnet layer and the magnets adjacent to the aperture are reduced in size in order to free space for the aperture. On each layer the normal magnets adjacent to the aperture are replaced with several smaller magnets. The preferred number of smaller magnets per normal magnet is 2 or 3. This is illustrated by the configurations B and D in FIG. 8. (3) The aperture replaces one or two magnets per magnet layer. This is illustrated by the configurations E and F in FIG. 8. In configuration E the aperture replaces two magnets in the layer adjacent to the column and one in the next layer. In configuration F the aperture replaces one magnet in the layer adjacent to the column and two magnets in the next layer. (4) The aperture replaces one magnet on some magnet layers and is inserted between two magnets on other magnet layers. On the layers in which the aperture is inserted between two magnets, the magnets adjacent to the aperture are reduced in size in order to free space for the aperture. On each of these layers the normal magnets adjacent to the aperture are replaced with several smaller magnets. The preferred number of smaller magnets per normal magnet is 2 or 3. This is illustrated by the configurations G and H in FIG. 8. In configuration G the aperture is inserted between two magnets in the layer adjacent to the column. Each normal magnet adjacent to the aperture is replaced with two smaller magnets. The aperture replaces one magnet in the next layer. In configuration H the aperture replaces one magnet in the layer adjacent to the column and is inserted between two magnets in the next layer. Each normal magnet adjacent to the aperture is replaced with two smaller magnets. In general the preferred way of inserting the apertures is way (2).

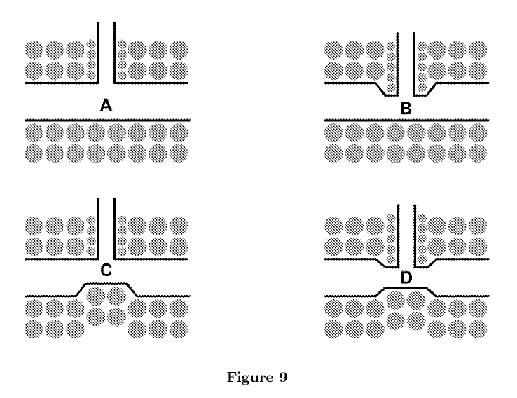

In certain configurations of magnets an aperture significantly reduces the presence of magnets along the column thus weakening both the magnetic field and the magnetic field gradient. The force inducing the motion of the bed is at its weakest at the centre of the column at the level of an aperture; this point is the functional limit of the whole system. Reducing the diameter or the thickness of the column in the vicinity of an aperture and positioning the magnets inside the bend increases the magnitude of the force moving the bed more than the magnitude of the viscous drag hence it improves the overall performance of the column. The diameter or the thickness of the column may be reduced in three ways, which are illustrated in FIG. 9. (1) The aperture and the nearby magnets on the aperture side of the column are positioned in an inward bend (configuration B in FIG. 9) that reduces the diameter of the column where the aperture is formed. (2) The magnets opposite the aperture are positioned in an inward bend (configuration C in FIG. 9) that reduces the diameter of the column where the aperture is formed. (3) The aperture, the magnets on the aperture side of the column and the magnets on the opposite side of the column to the aperture are positioned in inward bends (configuration D in FIG. 9) that reduce the diameter of the column where the aperture is formed. Lastly configuration A in FIG. 9 shows an aperture and magnets without reduction in thickness of the column. Preferably, in the above-described embodiments, the diameter or the thickness of the column are reduced by 30% to 60%, preferably by 40% to 50%, more preferably by about 50%. An alternative solution to reducing the diameter or thickness of the column is to use magnets with a higher magnetic remanence in the vicinity of the column.

### Shielding

The system comprised of the column, the magnets and the device moving the magnets is encased in a material providing magnetic shielding so as to protect the outside environment from the interference of strong magnetic fields. Good shielding materials are the materials with relative magnetic permeability above 60. The preferred shielding materials are nickel-iron alloys and grain oriented silicon steels. The preferred nickel-iron alloys are the mumetal and nilomag families of alloys. Other shielding materials may be used if deemed more useful in a particular situation.

### Continuous Chromatography Units

In some embodiments a single solution flows through the column. In other embodiments two different solutions flow through the column. In other embodiments three or more solutions may flow through the column. The solutions used may be feed solutions containing a target substance or target substances, eluents or buffer solutions as appropriate to the circumstances.

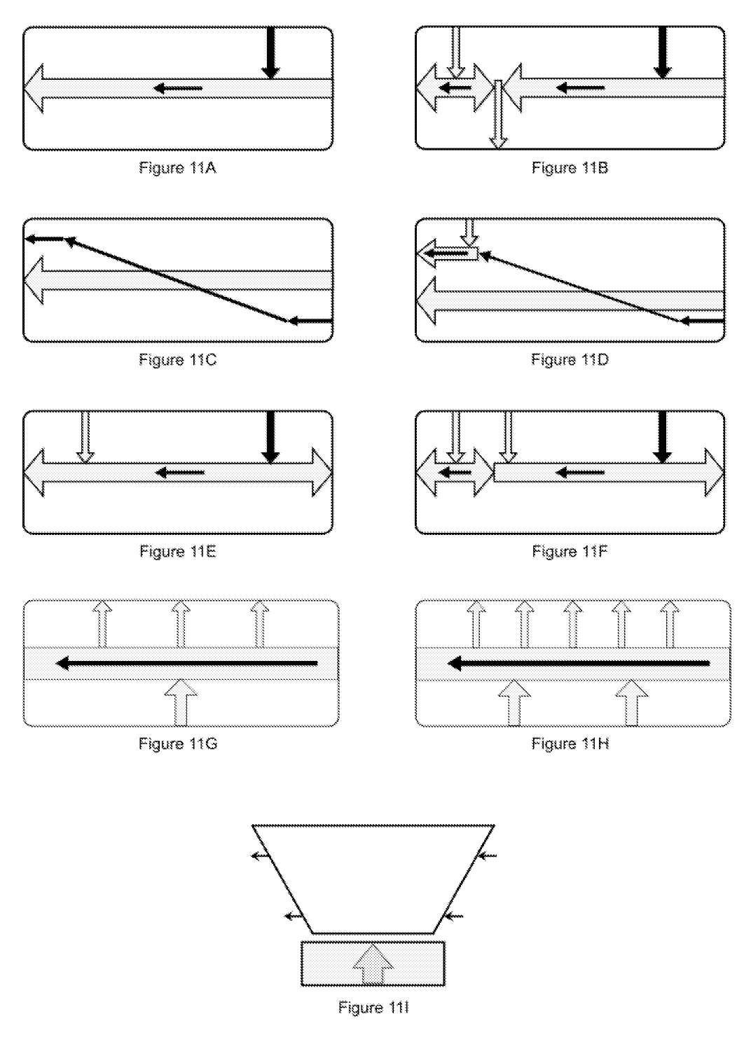

FIG. 11A shows an embodiment in which a single solution flows through the column in the same direction as the magnetic particles. The column has a first end, a second end and an aperture near the first end. The first end is the solution inlet. The solution enters the column through the first end and flows out through the second end. The aperture is the particle inlet. The magnetic particles enter the column through the aperture, move in the same direction as the solution and exit through the second end which is an outlet for both solution and particles.

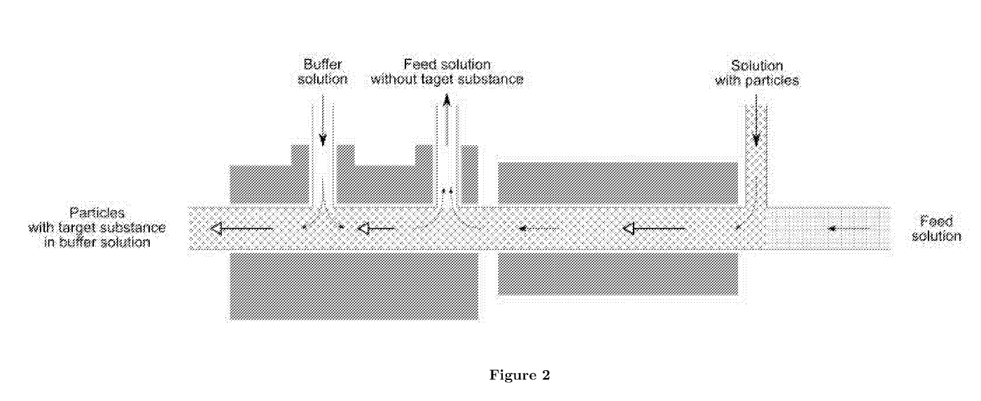

FIG. 11B shows an embodiment in which two different solutions flow through the column and the magnetic particles move in the same direction as the flow of the fluid. The column has a first end, a second end, and three apertures: the first aperture is located near the first end; the third aperture is located near the second end; the second aperture is positioned between the first and third apertures and located near the third aperture. The first direction is from the first end to the second end of the column. The second direction is from the second end to the first end of the column. The first end is the primary inlet; the first solution enters the column through the first end, flows in the first direction until the second aperture and flows out of the column through the second aperture. The third aperture is the secondary inlet; the second solution enters the column through the third aperture and flows in both directions. The part that flows in the second direction reaches the second aperture and flows out of the column through the second aperture which is the solution outlet. The part that flows in the first direction flows out of the column through the second end. The first aperture is the particle inlet; the magnetic particles enter the column through the first aperture, move in the first direction and exit the column through the second end which is the particle outlet. The magnetic particles are solvated by the first solution from the first aperture to the second aperture and by the second solution from the second aperture to the second end. The embodiment of FIG. 2 furthers the current embodiment.

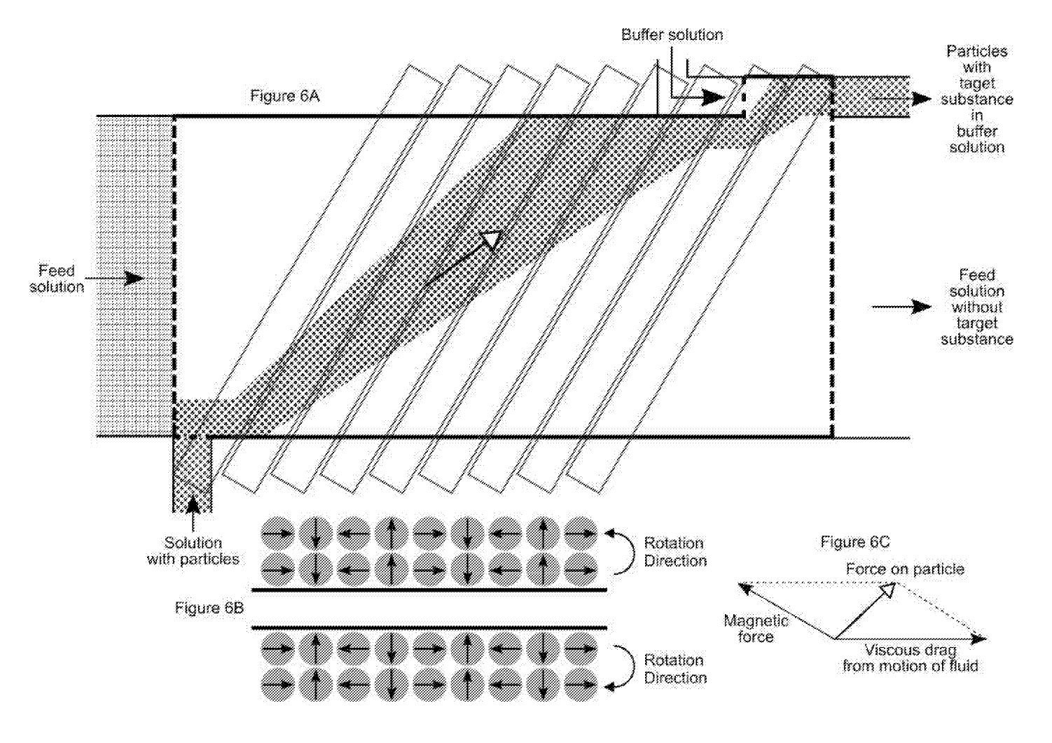

FIG. 11C shows an embodiment in which a single solution flows through the column and the magnetic particles move at a specific angle to the axis of the column. The column has a first end, a second end, a first side and a second side. The first end is divided into two inlets: a solution inlet and a particle inlet positioned towards the first side. The second end is divided in two outlets: the first outlet borders the first side; the second outlet borders the second side. A solution enters the column through the first end and flows out of the column through both outlets at the second end. The magnetic particles enter the column through the particle inlet, move at a specific angle to the fluid towards the second end and the second side and exit the column only through the second outlet, which is a particle outlet, at the second end. FIG. 11D shows an embodiment in which two different solutions flow through the column and the magnetic particles move at a specific angle to the axis of the column. The column has a first end, a second end, a first side, a second side. The column has two apertures: a first aperture on the first side near the first end; a second aperture on the second side near the second end. The first end is an inlet, which is the primary inlet. The second end is divided in two outlets: the first outlet is towards the first side and is the solution outlet; the second outlet is towards the second side and is the particle outlet. A first solution enters through first end, flows towards the second end and flows out of the column only through the first outlet at the second end. A second solution enters the column through the second aperture, flows towards the second end and the first side and flows out of the column through both outlets at the second end; the second solution pushes the first solution away from the second outlet. The magnetic particles enter the column through the first aperture, move at a specific angle to the fluid towards the second end and the second side and exit the column only through the second outlet at the second end. The magnetic particles are solvated by the first solution after they enter the column, and by the second solution as they exit the column. The embodiment in FIG. 6 furthers the current embodiment.

FIG. 11E shows an embodiment in which a single solution flows through the column in the opposite direction to the magnetic particles. The column has a first end and a second end. The column has two apertures: a first aperture near the first end and a second aperture near the second end. The first direction is from the first end to the second end; the second direction is from the second end to the first end. The solution enters the column through the second aperture, which is the solution inlet, flows in both directions, and flows out through both the first and second ends. The first end is the solution outlet. The magnetic particles enter the column through the first aperture, which is the particle inlet, move in the first direction and exit through the second end, which is the particles outlet. Between the first and second apertures the magnetic particles move in the direction opposite to the fluid flow. Between the second aperture and the second end, the magnetic particles move in a direction with the fluid flow.

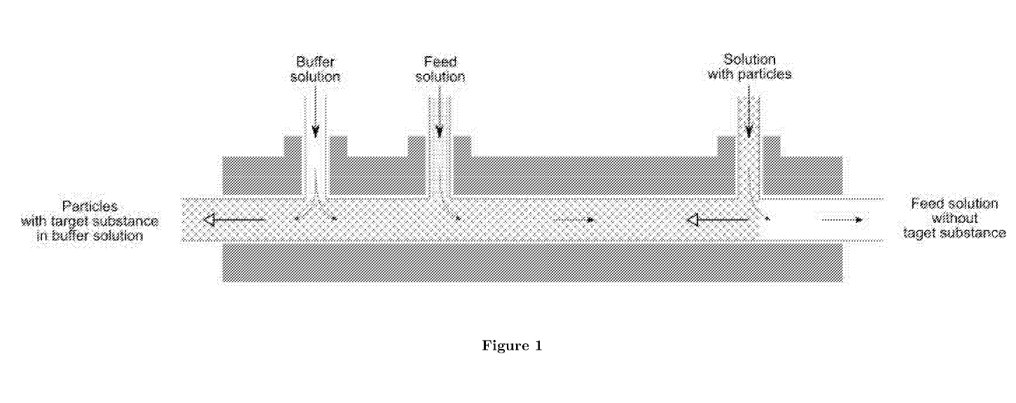

FIG. 11F shows an embodiment in which two different solutions flow through the column and the magnetic particles mostly move in the direction opposite to the flow of the fluid. The column has a first end, a second end, and three apertures: the first aperture is located near the first end; the third aperture is located near the second end; the second aperture is positioned between the first and third apertures, towards the third aperture. The first direction is from the first end to the second end of the column. The second direction is from the second end to the first end of the column. The first solution enters the column through the third aperture, which is the secondary inlet, and flows in both directions. The part that flows in the first direction flows out of the column through the second end. The part that flows in the second direction, flows until it reaches the second aperture. A second solution, containing the target substance, enters the column through the second aperture, which is the primary inlet. The first and second solutions may be miscible or immiscible. The first and second solutions flow in the second direction and flow out of the column through the first end, which is the solution outlet. The magnetic particles enter the column through the first aperture, which is the particle inlet, move in the first direction and exit the column through the second end, which is the particle outlet. Between the first and third apertures the magnetic particles move in the direction opposite to the flow of the fluid. The magnetic particles are solvated by the first and second solutions when they enter the column, and by the second solution when they exit the column. The embodiments in FIGS. 1, 3, 4 and 5 further the current embodiment.

FIG. 11G shows an embodiment in which a single solution flows through the column and the magnetic particles move in a direction perpendicular to the flow of the fluid. The column has a first end, a second end, a first side and a second side, and four apertures: the first aperture is on the first side of the column; the first aperture may be positioned at point midway between the first and second ends; the second aperture is on the second side close to the first end; the third aperture is on the second side between second and fourth apertures; the fourth aperture in on the second side close to the second end. A solution flows in the column through the first aperture, which is the solution inlet, and flows through the column from the first side to the second side, then flows out of the column through the second, third and fourth apertures, which are the solution outlets. The magnetic particles enter the column through the first end, which is the particle inlet, move towards the second end of the column in a direction perpendicular to the flow of the fluid and exit the column through the second end, which is the particle outlet. The amount of fluid entering the column with the magnetic particles through the first end and the amount of fluid exiting the column with the magnetic particles through the second end may be negligible compared to the amount of fluid flowing through the apertures.

FIG. 11H shows an embodiment in which two different solutions flow through the column and the magnetic particles move in a direction perpendicular to the flow of the fluid. The column has a first end, a second end, a first side and a second side, and seven apertures: the first and second apertures are found on the first side, for example the first aperture may be found on the first side close to the first end; the second aperture may be found on the first side close to the second end; the third aperture is on the second side close to the first end. The third to seventh apertures are disposed successively on the second side, and may be evenly spaced between the first and second ends. A first solution flows in the column through the first aperture and a second solution flows in the column through the second aperture; the first and second apertures are the solution inlets. The solutions flow through the column from the first side to the second side and partially mix if they are miscible. The solutions flow out of the column through the third to seventh apertures; the third through seventh apertures are the solution outlets. The magnetic particles enter the column through the first end, which is the particle inlet, move towards the second end of the column in a direction perpendicular to the flow of the fluid and exit the column through the second end, which is the particle outlet. The magnetic particles are solvated by the first solution when they enter through the first end, by the second solution when they exit through the second end and by a mixture of varying composition as they move through the column. The amount of fluid entering the column with the magnetic particles through the first end and the amount of fluid exiting the column with the magnetic particles through the second end may be negligible compared to the amount of fluid flowing through the apertures.

For the embodiments of FIGS. 11G and 11H, the solutions used may be feed solutions containing a target substance or target substances, eluents or buffer solutions as appropriate to the circumstances. These embodiments may be used in elution of a target substance or target substances. As the magnetic particles advance through the column, they disperse due to variations in their magnetic and hydrodynamic properties. However, the overall direction of their movement is perpendicular to the direction of the flow of the eluents. As the magnetic particles move through the column, the target substance or target substances progressively disassociate or desorb from them under the influence of the eluents. The target substances are dissolved in the eluents and flow out of the column with them through the solution outlets.

FIG. 11I shows the symbol of magnetically enhanced decanter; a shorter name for the unit is magnetic decanter. The magnetic decanter consists of a vessel made of a non-magnetic material and of a set of magnets positioned nearby. The magnets may be permanent magnets or electromagnets. The magnetic field enhances the sedimentation of magnetic particles; its exact spatial form and temporal profile depend on the particular situation. The vessel has a top, a bottom, a first side and a second side. The vessel has two inlets on the first side: a first inlet positioned near the top and a second inlet near the bottom. The vessel has two outlets on the second side: a first outlet near the top and a second outlet near the bottom. In its main use, it exchanges the carrier solution of the magnetic particles. A first solution carrying magnetic particles enters the vessel through the first inlet and flows out of the first outlet. A second solution enters the vessel through the second inlet and flows out through both outlets. The magnetic particles settle through the combined effects of gravity and magnetic field. The magnetic particles exit the vessel through the second outlet carried out by the second solution.

A unit operation embodying the apparatus of the present invention is generally called a continuous magnetic unit. The embodiments shown in FIGS. 11B, 11D and 11F are operationally equivalent to, respectively, the embodiments shown in FIGS. 11A, 11C and 11E followed by a magnetic decanter. Thus the embodiments shown in FIGS. 11A, 11C and 11E are respectively called simple continuous co-current magnetic unit, simple continuous specific angle magnetic unit, and simple continuous counter-current magnetic unit. The embodiments shown in FIGS. 11B, 11D and 11F are respectively called continuous co-current magnetic unit with solvent or buffer substitution, continuous specific angle magnetic unit with solvent or buffer substitution, and continuous counter-current magnetic unit with solvent or buffer substitution. The embodiments shown in FIGS. 11G and 11H are called continuous cross-current magnetic units. In cross-current magnetic units, the particles move in a direction that is perpendicular to the flow of the feed solution. Continuous cross-current magnetic units other than the ones shown in FIGS. 11G and 11H are possible: the number of inlet and outlet apertures varies according to need; a side of the column may have both inlet and outlet apertures; the fluid flowing in and out of the column ends may be negligible or play a role. When the magnetic particles carry multiple target substances, the target substances may be separated based on their affinity with the particles. For example, one target substance may be eluted for each outlet from the column. The number of inlet apertures may be one or more, or between 1 and 20, preferably between 1 and 10, most preferably between 1 and 5. The number of outlet apertures may be one or more, or between 1 and 20, between 1 and 10, between 2 and 8, preferably between 3 and 7. The embodiment in FIG. 11G is specifically called a one-inlet-three-outlet continuous cross-current magnetic unit. The embodiment in FIG. 11H is specifically called a two-inlet-three-outlet continuous cross-current magnetic unit.

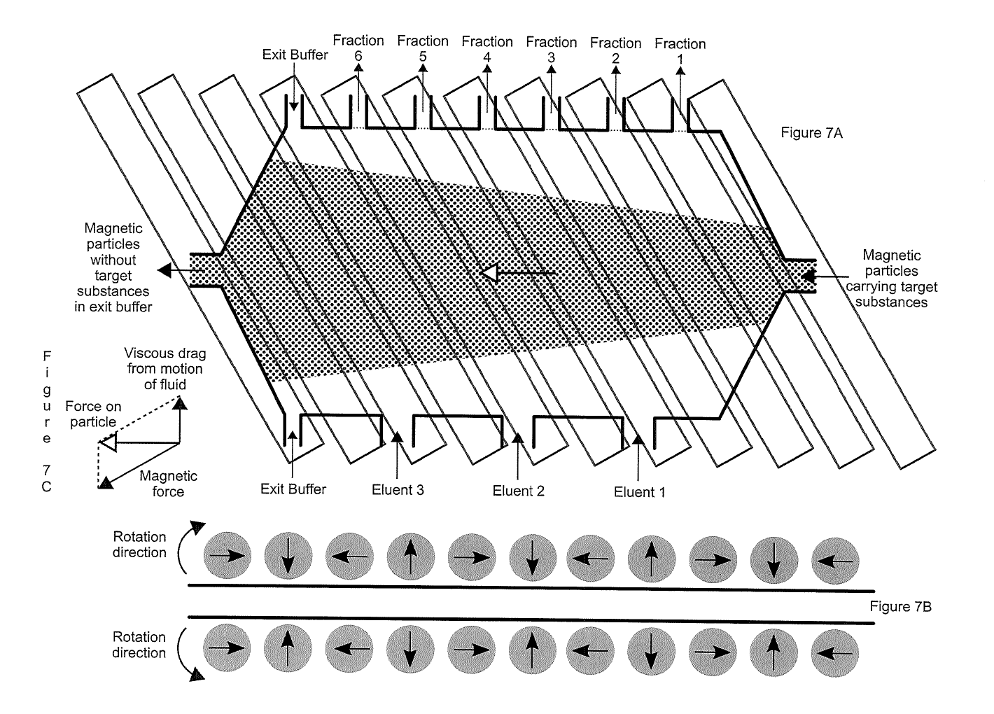

The embodiment shown in FIG. 7 illustrates the flexibility: it is a five-inlet-six-outlet continuous cross-current magnetic unit with four inlet apertures on one side and one inlet and six outlet apertures on the opposite side; the solution entering the column with the magnetic particles is negligible whereas the fluid exiting the column with the magnetic particles has a significant flow rate and carries the particles to the next processing step.

The magnetic decanter shown in FIG. 11I may also be used to concentrate the magnetic particles. In this use, a solution carrying the particles enters the vessel through the first inlet and exits through both outlets. The magnetic particles settle through the combined effects of gravity and magnetic field. The magnetic particles exit the vessel through the second outlet carried out by the solution, their concentration having markedly increased.

### Method for Continuous Chromatography

Chromatography performed using a column with a solid bed consists of four general steps: (1) loading of the target substance onto the bed; (2) washing of the bed; (3) elution of target substance or target substances from the bed; (4) cleaning and regeneration of the bed. The loading step and the elution step are always present. The washing step and the cleaning/regeneration step may occasionally be omitted. Usually the four steps are performed consecutively in the same column. The continuous magnetic units can perform each step continuously. A process employing two or more continuous magnetic units can perform continuous chromatography: a first unit is necessary for the loading; a second unit is necessary for the elution; a third unit may be used either for washing or for regeneration; a fourth unit may be used for the last step; more units may be added to supplement one of the steps. The continuous magnetic units may be used in conjunction with one or more simple decanters, or with one or more magnetic decanters.

In this section a “waste stream” refers to a fluid resulting from the continuous chromatography process which has no further use within the scope of the process for continuous chromatography under consideration.

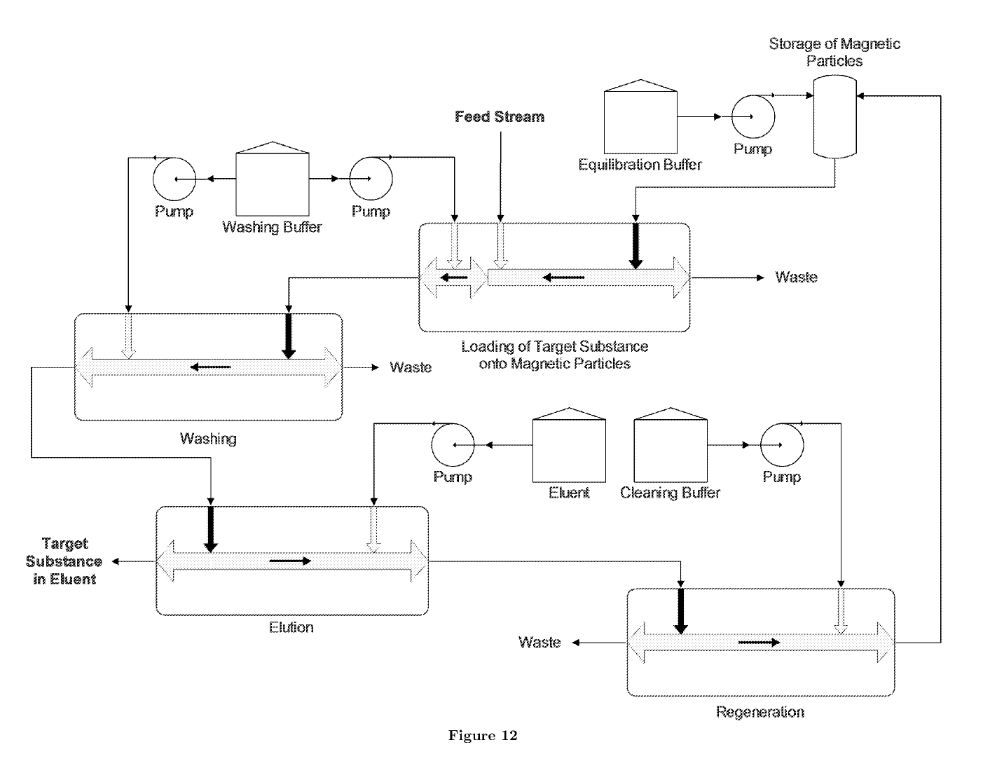

FIG. 12 shows the flowchart of an embodiment of continuous chromatography. The four steps are performed by chromatography units functioning with the bed moving in counter-current to the fluid. The chromatography unit performing the loading is a continuous counter-current chromatography unit with buffer substitution; it substitutes the washing buffer to the feed stream. The three other chromatography units are simple continuous counter-current chromatography units. The four chromatography units are connected in a loop and the magnetic particles cycle through them.

In use, the feed stream flows in the chromatography unit performing the loading through the primary inlet, flows out through the solution outlet, and becomes a waste stream. The magnetic particles are drawn from a storage vessel, enter the chromatography unit performing the loading through the particle inlet, capture the target substance from the feed stream, transition to the washing buffer, then exit through the particle outlet. The washing buffer is pumped from a storage vessel, flows in the chromatography unit performing the loading through the secondary inlet, and flows out through both outlets. The part of the washing buffer that flows out through the solution outlet becomes a waste stream.

Next the magnetic particles enter the chromatography unit performing the washing through the particle inlet, undergo the washing by the washing buffer, and exit through the particle outlet. The washing buffer is pumped from a storage vessel, flows in the chromatography unit performing the washing through the solution inlet, and flows out through both outlets. The part of the washing buffer that flows out through the solution outlet becomes a waste stream.

Next the magnetic particles enter the chromatography unit performing the elution through the particle inlet, release the target substance, and exit through the particle outlet. The elution buffer is pumped from a storage vessel, flows in the chromatography unit performing the elution through the solution inlet, and flows out through both outlets. The part of the elution buffer that flows out through the solution outlet carries the target substance to the next processing unit.

Next the magnetic particles enter the chromatography unit performing the regeneration through the particle inlet, undergo cleaning and restoration in order to be reusable again, and exit through the particle outlet. The cleaning and restoration buffer is pumped from a storage vessel, flows in the chromatography unit performing the regeneration through the solution inlet, and flows out through both outlets. The part of the cleaning and restoration buffer that flows out through the solution outlet becomes a waste stream.

Next the magnetic particles enter their storage vessel. An equilibration buffer is pumped in the storage vessel to mix with the cleaning and restoration buffer and create the storage buffer of the magnetic particles. The pumping of the equilibration buffer also creates the flow that carries the magnetic particles to the chromatography unit performing the loading.

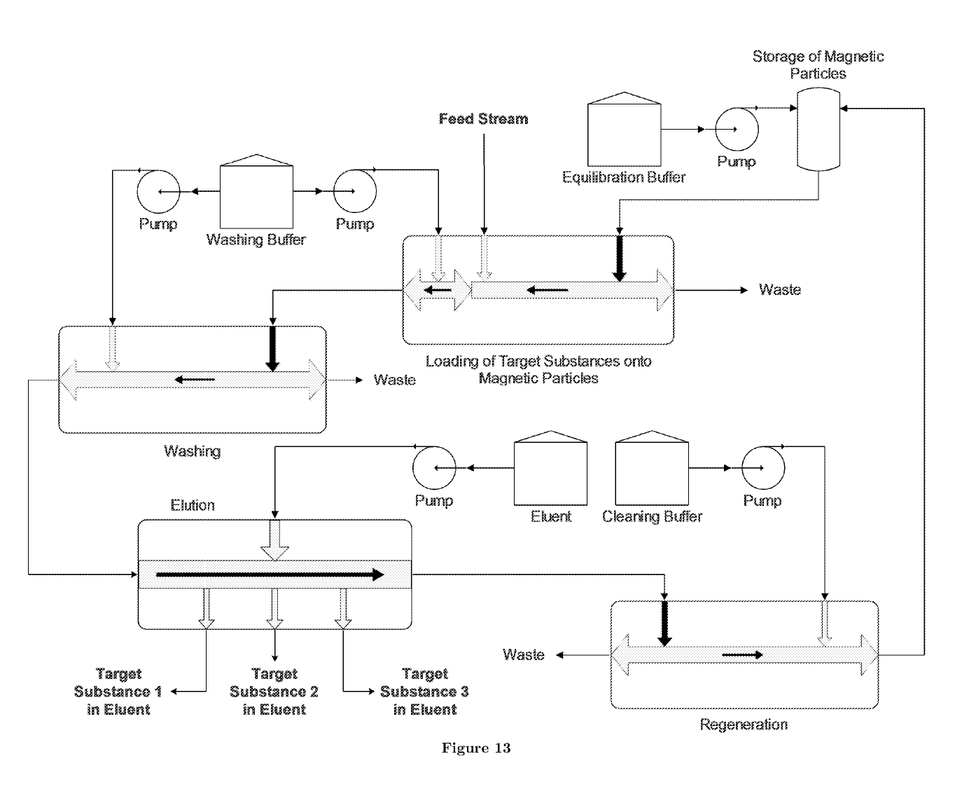

FIG. 13 shows the flowchart of an embodiment of continuous chromatography. Three of the four steps are performed by magnetic units functioning with the bed moving counter-current to the fluid and one step is performed by a magnetic unit with the bed moving in cross-current to the fluid. The chromatography unit performing the loading is a continuous counter-current magnetic unit with buffer substitution; it substitutes the washing buffer to the feed stream. The chromatography unit performing the elution is a one-inlet-three-outlet continuous cross-current magnetic unit. The two other chromatography units are simple continuous counter-current magnetic units. The four chromatography units are connected in a loop and the magnetic particles cycle through them.

In use, the feed stream flows in the chromatography unit performing the loading through the primary inlet, flows out through the solution outlet, and becomes a waste stream. The magnetic particles are drawn from a storage vessel, enter the chromatography unit performing the loading through the particle inlet, capture the target substance or target substances from the feed stream, transition to the washing buffer, then exit through the particle outlet. The washing buffer is pumped from a storage vessel, flows in the chromatography unit performing the loading through the secondary inlet, and flows out through both outlets. The part of the washing buffer that flows out through the solution outlet becomes a waste stream.

Next the magnetic particles enter the chromatography unit performing the washing through the particle inlet, undergo the washing by the washing buffer, and exit through the particle outlet. The washing buffer is pumped from a storage vessel, flows in the chromatography unit performing the washing through the solution inlet, and flows out through both outlets. The part of the washing buffer that flows out through the solution outlet becomes a waste stream.

Next the magnetic particles enter the chromatography unit performing the elution through the particle inlet, release the target substances, and exit through the particle outlet. The elution buffer is pumped from a storage vessel, flows in the chromatography unit performing the elution through the single solution inlet, and flows out through the three solution outlets; a small fraction of the elution buffer flows out of the particle outlet and carries the magnetic particles to the regeneration step. The elution buffer that flows out through the three solution outlets carries the target substance to the next processing units. Three target substances are separated based on their affinity with the particles, one per outlet.

Next the magnetic particles then enter the chromatography unit performing the regeneration through the particle inlet, undergo cleaning and restoration in order to be reusable again, and exit through the particle outlet. The cleaning and restoration buffer is pumped from a storage vessel, flows in the chromatography unit performing the regeneration through the solution inlet, and flows out through both outlets. The part of the cleaning and restoration buffer that flows out through the solution outlet becomes a waste stream.

Next the magnetic particles enter their storage vessel. An equilibration buffer is pumped in the storage vessel to mix with the cleaning and restoration buffer and create the storage buffer of the magnetic particles. The pumping of the equilibration buffer also creates the flow that carries the magnetic particles to the chromatography unit performing the loading.

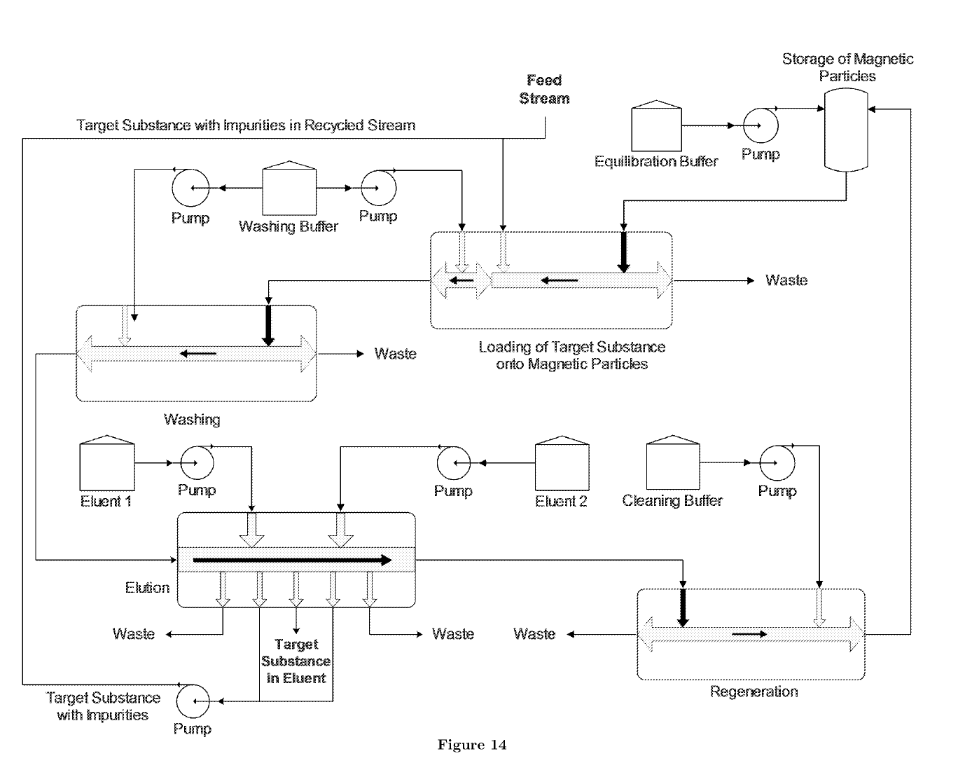

FIG. 14 shows the flowchart of another embodiment of continuous chromatography. Three of the four steps are performed by magnetic units functioning with the bed moving in counter-current to the fluid and one step is performed by a magnetic unit with the bed moving in cross-current to the fluid. The chromatography unit performing the loading is a continuous counter-current magnetic unit with buffer substitution; it substitutes the washing buffer to the feed stream. The chromatography unit performing the elution is a two-inlet-five-outlet continuous cross-current magnetic unit. The two other chromatography units are simple continuous counter-current magnetic units. The four chromatography units are connected in a loop and the magnetic particles cycle through them. The chromatography units performing the loading, washing and elution are connected in a second loop which recycles part of the target substance which is mixed with impurities.

In use, the feed stream carrying the target substance is mixed with the recycle stream carrying the target substance mixed with impurities, then flows in the chromatography unit performing the loading through the primary inlet, flows out through the solution outlet, and becomes a waste stream. The magnetic particles are drawn from a storage vessel, enter the chromatography unit performing the loading through the particle inlet, capture the target substances from the feed stream, transition to the washing buffer, then exit through the particle outlet. The washing buffer is pumped from a storage vessel, flows in the chromatography unit performing the loading through the secondary inlet, and flows out through both outlets. The part of the washing buffer that flows out through the solution outlet becomes a waste stream.

Next the magnetic particles enter the chromatography unit performing the washing through the particle inlet, undergo the washing by the washing buffer, and exit through the particle outlet. The washing buffer is pumped from a storage vessel, flows in the chromatography unit performing the washing through the solution inlet, and flows out through both outlets. The part of the washing buffer that flows out through the solution outlet becomes a waste stream.

Next the magnetic particles enter the chromatography unit performing the elution through the particle inlet, release the target substance and other impurities, and exit through the particle outlet. Two elution buffers are pumped from their respective storage vessels, flow in the chromatography unit performing the elution through the two solution inlets, mix partially in the column and flow out through the five solution outlets; a small fraction of one of the elution buffers flows out of the particle outlet and carries the magnetic particles to the regeneration step. The elution buffer flowing through the solution outlet closest to the particle inlet carries the early eluting impurities and becomes a waste stream. The elution buffer flowing through the solution outlet closest to the particle outlet carries the late eluting impurities and becomes a waste stream. The elution buffer flowing through the middle solution outlet carries the target substance at its highest purity to the next processing step. The elution buffer flowing through the solution outlet second closest to the particle inlet and the elution buffer flowing through the solution outlet second closest to the particle outlet carry the target substance mixed with impurities. These elution buffers are mixed and form the recycle stream which is subsequently joined with the feed stream arriving at the chromatography unit performing the loading.

Next the magnetic particles enter the chromatography unit performing the regeneration through the particle inlet, undergo cleaning and restoration in order to be reusable again, and exit through the particle outlet. The cleaning and restoration buffer is pumped from a storage vessel, flows in the chromatography unit performing the regeneration through the solution inlet, and flows out through both outlets. The part of the cleaning and restoration buffer that flows out through the solution outlet becomes a waste stream.

Next the magnetic particles enter their storage vessel. An equilibration buffer is pumped in the storage vessel to mix with the cleaning and restoration buffer and create the storage buffer of the magnetic particles. The pumping of the equilibration buffer also creates the flow that carries the magnetic particles to the chromatography unit performing the loading.

The pumps shown in FIGS. 12, 13 and 14 are necessary for operating the process. They may be positioned at different points in the process. Other pumps and valves may be added in order to manage the pressure and flow rates. The pumps are drawn as rotary pumps; nevertheless they may be substituted with any other kind of pump deemed appropriate in a particular situation.

Any continuous counter-current magnetic unit shown in FIGS. 12, 13 and 14 may be substituted with either another continuous magnetic unit, or with a simple decanter, or with a magnetic decanter, or with a combination of a continuous magnetic unit and a simple decanter, or with a combination of a continuous magnetic unit and a magnetic decanter, or with a combination of decanters.

### Examples

The following examples are provided for illustrative purposes only, and should not be construed as limiting the present invention as defined by the claims.

FIG. 1 shows the schema of a general embodiment of the apparatus according to the present invention operating in counter-current mode. In this embodiment the apparatus performs the loading of a target substance onto a bed moving in the opposite direction to the fluid carrying the target substance. The apparatus comprises a column with two ends and three apertures, and several sets of strong magnets. In FIG. 1 the first direction is leftward along the axis column and the second direction is rightward along the axis of the column. A buffer solution, with no effect on the binding of the target substance to the magnetic particles, enters the column through a first aperture closest to a first end of the column, shown as furthest to the left in FIG. 1. Part of the buffer solution flows in the first direction towards a first end of the column and part of the buffer solution flows in the second direction towards a second end of the column under two diverging pressure gradients. The feed solution enters the column through a second aperture, positioned between the first and third apertures. The second aperture is positioned further along the column from the first aperture in the second direction. The feed solution flows from the second aperture in the second direction under a pressure gradient. The magnetic particles constituting the bed enter the column through a third aperture, closest to a second end of the column, shown as the aperture furthest to the right in FIG. 1. The third aperture is positioned further along the column from the second aperture in the second direction. The magnetic particles are carried by a solution in which they can be stored long term and which does not interfere with the binding of the target substance to the particles: the storage buffer. The storage buffer mixes with the feed solution depleted of the target substance and flows out of the column through the opening at its second end. Sets of strong magnets are positioned on opposite sides of the column along a portion of the length of the column that includes the first, second and third apertures. The magnets generate a magnetic field which catches the magnetic particles as they enter the column through the third aperture and prompts them to move in the first direction, against the flow of the feed solution. The target substance attaches onto the magnetic particles as the particles move in the first direction until they reach the second aperture. The magnetic particles with the target substance attached to them keep moving in the first direction past the second aperture then past the first aperture, mixing with the buffer solution. Once the magnetic particles reach the opening at the second end of the column they are carried by the buffer solution to the next unit operation.

FIG. 2 shows the schema of another general embodiment of the apparatus according to the present invention operating in a co-current mode. In this embodiment the apparatus performs the loading of a target substance onto a bed moving in the same direction as the fluid carrying the target substance. Again, the apparatus comprises a column with two ends and three apertures, and several sets of strong magnets. In FIG. 2 the first direction is leftward along the axis column and the second direction is rightward along the axis of the column. The feed solution enters the column through the opening at a first end of the column, shown as the right hand end in FIG. 2, and flows in the first direction towards the second end of the column under a pressure gradient. The magnetic particles constituting the bed enter the column through a first aperture, closest to the first end of the column, shown as the aperture furthest to the right in FIG. 2. The magnetic particles are carried by a solution in which they can be stored for long term and which does not interfere with the binding of the target substance to the particles: the storage buffer. The storage buffer containing the particles mixes with the feed solution: the result of the mixing is named the feed mixture and flows in the first direction. Sets of strong magnets are positioned on opposite sides of the column and generate a magnetic field which catches the magnetic particles as they enter the column and prompts the particles to move in the first direction, i.e. in the same direction as the flow of the feed mixture. The magnetic particles may move faster or more slowly than the feed mixture, or at the same speed. The target substance attaches onto the magnetic particles as they move in the first direction until they reach a second aperture, shown as the middle aperture in FIG. 2. A buffer solution, with no effect on the binding of the target substance to the magnetic particles, enters the column through the third aperture, closest to the second end of the column, shown as the aperture furthest to the left in FIG. 2. Part of the buffer solution flows in the first direction and part of the buffer solution flows in a second direction under two diverging pressure gradients. The second aperture is positioned further along the column in the first direction from the first aperture, between the first and third apertures. At the level of the second aperture the feed mixture is depleted of the target substance and runs into the buffer solution flowing in the second direction. The feed mixture and the buffer solution mix and flow out of the column through the second aperture. At the second aperture the magnetic field prevents the magnetic particles from flowing out of the column. Alternatively a filter preventing the outflow of the particles may be used to supplement or replace the magnetic field. Thus, the magnetic particles with the target substance attached to them remain in the column and flow leftward in the first direction, first against then in the same direction as the buffer solution. Once the magnetic particles reach the opening at the second end of the column, shown as the left hand end in FIG. 2, they are carried by the buffer solution to the next unit operation.

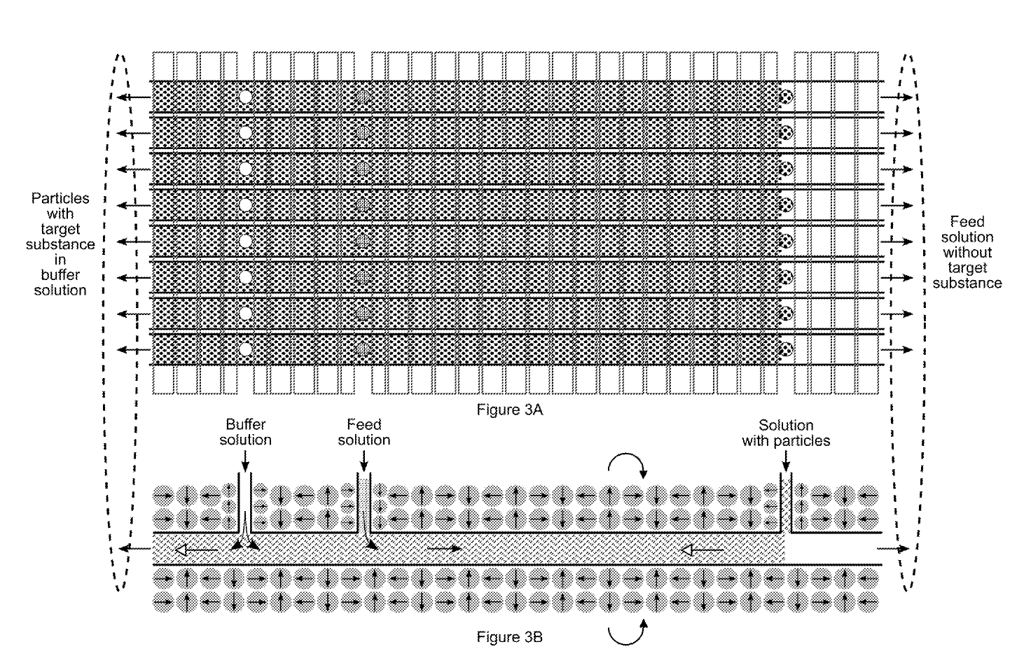

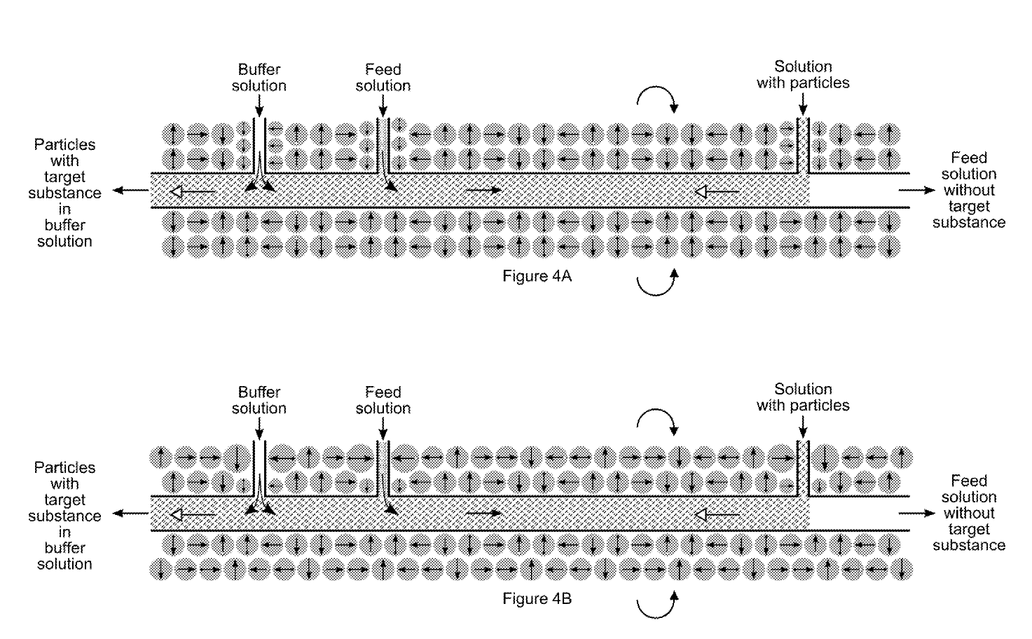

FIG. 3A shows the top view of an embodiment of the apparatus according to the present invention in which a plurality of columns are used in parallel. FIG. 3B shows a cross-sectional view of one of the columns in FIG. 3A. FIGS. 4A and 4B show the cross-sectional views of two other embodiments of the apparatus according to the present invention; for these two embodiments the top view is identical to the top view of FIG. 3A. All three embodiments are more specific embodiments of the general embodiment described by FIG. 1, and operate in counter-current mode. The characteristics common to the three embodiments are described in this paragraph. Static magnets are used to move the bed. In FIG. 3A, the top view shows the apparatus is made of several parallel columns. In this embodiment, the columns are cylindrical vessels with the same diameter. Eight such vessels are shown in FIG. 3A. As described previously for FIG. 1, each column has two ends and three apertures. The position of the apertures and the flow of the buffer solution, feed solution and the particles are as described for FIG. 1. In FIGS. 3 and 4, the magnets used are cylindrical and their magnetisation is in a direction perpendicular to the longitudinal axis of the magnets. The longitudinal axis of each of the magnets is positioned perpendicularly to the longitudinal axis of the columns. The magnets are positioned on opposite sides of the column, shown above and below the column in FIGS. 3B, 4A and 4B. In the embodiments shown in FIGS. 3B, 4A and 4B, two layers of magnets are provided on each side of the column. The length of each magnet extends across the diameters of all of the cylindrical vessels shown in parallel in FIG. 3A. The ends of the magnets extend beyond the outermost of the cylindrical vessels on each side by a length equal to the diameter of a single cylindrical vessel. The magnets are attached to a fixed non-magnetic support, which is not shown. This allows each magnet to rotate around its longitudinal axis. Most of the magnets provided along the length of the columns are regular magnets. Some of the magnets positioned near the apertures have a diameter half as large as the regular magnets; they are the smaller magnets. All magnets bear an arrow which shows the direction of their magnetisation in their initial state. When they rotate, the set of magnets on one side of the column rotate in the opposite direction to the set of magnets on the other side of the column. In FIGS. 3B, 4A and 4B this is shown as the magnets above the column rotating clockwise and the magnets below the column rotating anticlockwise.

In the embodiment of the apparatus shown in FIG. 3B, two layers of magnets are used on each side of the column. Each aperture is inserted between two regular magnets. Each regular magnet adjacent to the apertures is replaced with two smaller magnets. The arrangement of magnets within a layer is known as a Halbach array. The magnets rotate at constant velocity. The sequence of magnets is matched across the diameter of the column such that the directions of magnetisation of the magnets on one side are the mirror images of the directions of magnetisation of the magnets on the other side of the column.

In the embodiment of the apparatus shown in FIG. 4A two layers of magnets are used on each side of the column. Each aperture is inserted between two regular magnets. Each regular magnet adjacent to the apertures is replaced with two smaller magnets. The sequence of magnets is matched across the diameter of the column such that the directions of the magnetisation of the magnets on one side are the mirror images of the directions of the magnetisation of the magnets on the other side of the column.

In the embodiment of the apparatus shown in FIG. 4B two layers of magnets are used on each side of the column. Each aperture is inserted between two regular magnets in the layer adjacent to the column and replaces exactly one magnet in the next layer. Each regular magnet adjacent to the apertures in the layer adjacent to the column is replaced with two smaller magnets. The sequence of magnets is matched across the diameter of the column such that the directions of the magnetisation of the magnets on one side are the mirror images of the directions of the magnetisation of the magnets on the other side of the column.

For both embodiments shown in FIGS. 4A and 4B, the magnets are divided in multiple groups represented by the different starting points of the arrow representing their direction of magnetisation. Each magnet in an initial position has its direction of magnetisation in one of four possible directions separated by an angle of π/2. In a given layer, in the initial sequence of the magnets, the magnets arranged are in blocks of six, where, relative to a first magnet, the second and third magnets are rotated by an angle of π/2, the fourth magnet is rotated by an angle of π, and the fifth and sixth magnets are rotated by an angle of 3π/2. The sequence then repeats. The magnets in each group have the same angle of rotation θ. For all both embodiments shown, the directions of magnetisations of the magnets on one side are the mirror image of the directions of magnetisation of the magnets on the other side of the column. In FIGS. 4A and 4B, two layers of magnets are shown on opposite sides of the column. In FIG. 4A the second outer layer of magnets is positioned level with the first inner layer, whereas in FIG. 4B the second outer layer of magnets is staggered relative to the first inner layer. The rotation of the initial arrangements of magnets for FIGS. 4A and 4B is described depending on the starting position of the magnet. n is an integer indicating the position of magnet in its layer. n is increasing in the direction of the flow of magnetic particles. The origin n=0 is set on any magnet such that the magnetisation of the magnet in the position n−1 is in the same direction and that magnetisation of the magnet in position n+1 is in another direction. For the first rotation of π/2, for the magnets in a layer, every third magnet defined by a position (x) of x=3n, where n is an integer, remains stationary, whilst the other magnets rotate by an angle of π/2. For the second rotation of π/2, every third magnet in the layer defined by a position of x=3n+1 remains stationary, whilst the other magnets rotate by a further angle of π/2. For the third rotation of π/2, every third magnet in the layer defined by a position of x=3n+2 remains stationary, whilst the other magnets rotate by a further angle of π/2. During this process, the direction of magnetisation for each magnet is never rotated more than π/2 from the two magnets adjacent to it in a layer. In embodiments where one or more layers are present on opposite sides of the column, the layers on one side of the column rotate in the opposite direction to those on the other side. More generally, the rotation of the initial arrangements of magnets in the preceding paragraph is described using an auxiliary profile p, wherein:

t is time measured from the start of rotation of the magnets;

ν is a constant angular velocity expressed in radians per second;

T is a time constant associated to ν through

$$T = \frac{π}{2 v}$$

$$k = ⌊ \frac{t}{T} ⌋$$

$$p ( t ) = \vert \begin{matrix}0 & if k ≡ 0 [ 3 ] \\ v ( t - k \cdot T ) & if k ≡ 1 [ 3 ] \\ v ( t - ( k - 1 ) \cdot T ) & if k ≡ 2 [ 3 ]\end{matrix}$$

| Group by position in layer | Angle of Rotation - Auxiliary profile |
|---|---|
| Magnets in position x = 3n | θ(t) = p(t) |
| Magnets in position x = 3n + 1 | θ(t) = p(t + 2T) |
| Magnets in position x = 3n + 2 | θ(t) = p(t + T) |

In an embodiment that furthers the embodiment described in FIG. 4A, the column consists of 10 cylinders arranged in parallel with a length of 130 cm and with inner diameter between 0.8 cm and 1.5 cm. The wall of a cylinder is 0.5 mm to 2 mm thick and made of austenitic stainless steel. The space between the cylinders is between 0.5 mm and 2 mm. The apertures are cylindrical with an inner diameter less than half of the inner diameter of a cylinder from the column. The wall of an aperture has the same thickness as the wall of a cylinder from the column. The apertures are inserted between two magnets. Opposite the aperture the diameter of the cylinders is reduced in half over the length of two regular magnets by an inward bend; the magnets are positioned in this bend. The first aperture is placed less than 10 cm from the first end of the column, leaving enough space for 4 magnets to be positioned between the aperture and the first end. The third aperture is placed less than 10 cm from the second end of the column, leaving enough space for 4 magnets to be positioned between the aperture and the second end. The second aperture is placed less than 15 cm from the third aperture, leaving enough space for 6 magnets to be positioned between the apertures. The magnets are made of neodymium-iron-boron alloys with a magnetic remanence of 1.2 T or higher or of 1.25 T or higher. The magnets have a protective coating consisting of three layers: nickel layer, copper layer, nickel layer; the total thickness of the coating must be 15 microns or higher. The regular magnets are cylinders with a diameter between 0.8 cm and 1.5 cm, and with a length equal to 12 times the outer diameter of a cylinder from the column plus 9 times the spacing between two cylinders from the column. The smaller magnets are cylinders with a diameter between 0.5 and 0.75 times the diameter of regular magnets and with length equal to the length of the regular magnets. The space between the cylinders is between 0.5 mm and 1 mm. The magnets rotate as described in the preceding paragraph with angular velocity parameter ν between 0.01 rad/s and 1 rad/s or from 0.01 rad/s to 0.10 rad/s. The magnetic particles have a large core made of magnetite encased in a matrix of silica. They are spheroidal with a diameter between 10 microns and 20 microns. Their density is between 2200 kg/m³ and 2700 kg/m³, their overall relative magnetic permeability is at least 1.25, and their magnetisation at saturation is at least 3500 A/m. Between the first and second apertures, the fluid flows with a velocity between 10⁻⁴ m/s and 10⁻² m/s or between 10⁻⁴ m/s and 10⁻³ m/s.

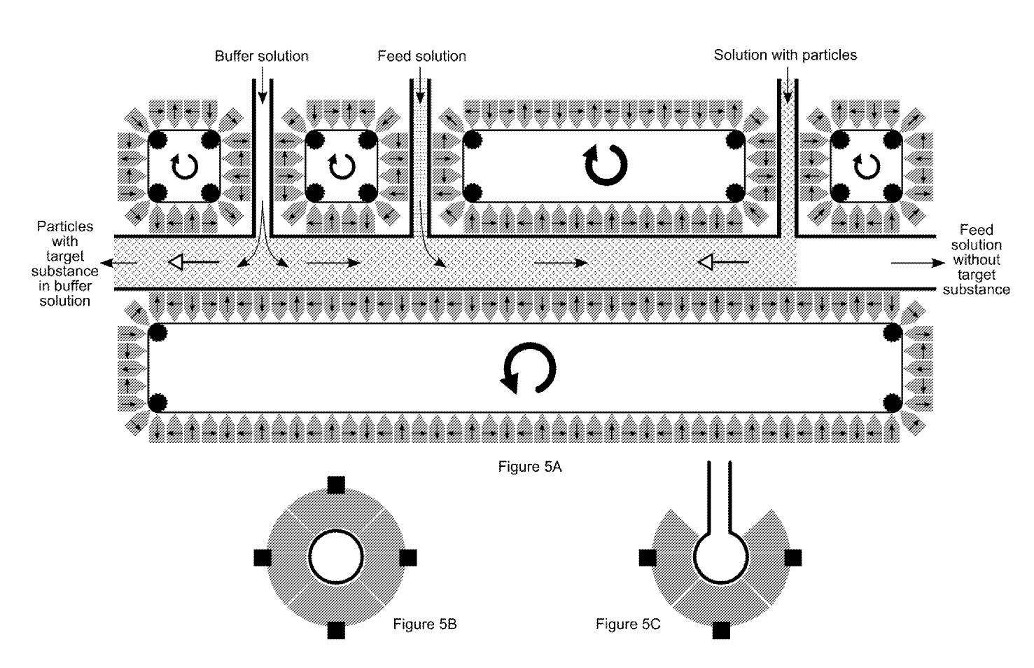

FIG. 5A shows the cross-sectional view of an embodiment of the apparatus according to the present invention, whilst FIGS. 5B and 5C show cross-sectional views of the column and magnets depicted in FIG. 5A. FIGS. 5A, B and C describe a more specific embodiment of the general embodiment described by FIG. 1. In this embodiment, mobile magnets are employed to move the bed. The column is made of a single cylindrical vessel with three apertures. In FIG. 5A, the position of the apertures and the flow of the buffer solution, feed solution and the particles are as described for FIGS. 1, 3 and 4. The magnets are attached to chains which run along the column. Each chain forms a closed loop; and it is held and moved by a mechanism represented by gearwheels. The chains and the mechanism are made of non-magnetic materials. Except at the level of apertures, four chains with magnets run along the length of the column in order to gird it. When an aperture interrupts the path of one of the chains, the chain with a path interrupted by the aperture splits into two separate chains to accommodate the aperture. The magnets are identical except for the direction of their magnetisation. In FIG. 5A the direction of magnetisation is shown by an arrow. The magnetisation is outwardly or inwardly radial relative to the diameter of the column for the magnets shown with up or down arrows; or in a direction parallel to the longitudinal axis of the column for the magnets shown with left and right arrows. The magnets are shown in their initial position. The sequence of magnets along the longitudinal axis of the column forms a Halbach array. The chains move the magnets surrounding the column in the first direction at uniform velocity. The magnets on each chain move at the same velocity in order to preserve the alignment across the diameter of the column. In use, a buffer solution enters the column through the first aperture and flows in both first and second directions along the column. A feed solution containing a target substance enters the column through the second aperture and flows in the first direction along the column, towards a second end of the column. A solution containing the particles enters the column through the third aperture and the particles are moved by the magnets in the second direction, counter-current to the flow of feed solution, towards the first end of the column. The feed solution without the target substance flows out of the second end of the column. Particles with the target substance bound flow out of the first end of the column.

FIG. 5B depicts a cross-section of the column and magnets at a point where there is not an aperture. In this view, the magnets have the form of a quarter of a hollow cylinder with an inner diameter slightly larger than the outer diameter of the column, such that four magnets surround the circumference of the column. In FIG. 5C, an aperture interrupts the path of one of the chains. As may be seen in FIG. 5A, when an aperture interrupts a set of magnets, the chain for the set of magnets on the side of the column in which the aperture is positioned is configured to move the magnets away from the column, along a side of the aperture in order to accommodate the aperture. Thus, on the side of the column on which the apertures are located, several sets of magnets are provided, each set linked to its chain and driving mechanism.

FIGS. 6A and 6B respectively show the top and cross-sectional views of an embodiment of the apparatus according to the present invention. In this embodiment the apparatus performs the loading of a target substance onto a bed moving at an acute angle to the direction of the fluid carrying the target substance. The bed is moved with static magnets. The column is a cuboid vessel with first and second ends, first and second sides and a top and a bottom face. The first end, shown on the left hand side of FIG. 6A, is an inlet. The second end, shown on the right hand side of FIG. 6A, is divided in two uneven contiguous outlets of different sizes: a larger one towards the first side and a smaller one towards the second side. The column has a first aperture on the first side near the first end and a second aperture on the second side near the second end; in FIG. 6A the first aperture is at the bottom on left hand side and the second aperture is at the top on the right hand side. The first aperture is perpendicular to the first side of the column and the second aperture joins the column in a direction parallel to the second side of the column. The second aperture is accommodated in this orientation by making the distance between the first and second sides wider at the second end of the column where the second aperture is formed, by an amount corresponding to the width of the second aperture, thus creating a kink in the second side of the column. The magnets are cylindrical and their magnetisation is in a direction perpendicular to a longitudinal axis of the magnets. The magnets are positioned above and below the column, at a specific angle to the longitudinal axis of the column. The magnets extend beyond the edge of the column on each side by a length corresponding to the thickness of the column.

In FIG. 6B, two layers of magnets are present above and below the column. In order to achieve the desired flow of particles, a first end of each magnet positioned over the first side of the vessel is closer to the first end of the vessel than a second end of each magnet positioned over the second side of the vessel, so that when viewed from the top, as shown in FIG. 6A, the magnets are positioned at an angle across the width of the column. The magnets are attached to a fixed non-magnetic support, which is not shown, which permits each magnet to rotate around its axis. The magnets are identical and bear an arrow which shows the direction of their magnetisation in their initial state. Within a layer of magnets, the magnetisations are in a sequence corresponding to a Halbach array. The alternating sequence of the direction of magnetisation of the magnets is matched across the diameter of the column such that the directions of magnetisations of the magnets on one side are the mirror images of the directions of magnetisation of the magnets on the other side of the column.

In use, the magnets rotate at a uniform angular velocity. When they rotate, the set of magnets on one side of the column rotate in the opposite direction to the set of magnets on the other side of the column at a constant velocity. In FIG. 6B, this is shown as the magnets above the column rotating clockwise and the magnets below the column rotating anticlockwise. The feed solution enters the column through the inlet at the first end of the cuboid vessel and flows in a first direction, rightward in FIG. 6B, under a pressure gradient. The feed solution, depleted of the target substance exits the column through the larger outlet of the second end of the cuboid vessel. The magnetic particles enter the column through the first aperture near the first end of the cuboid vessel carried by a buffer solution which does not interfere with the binding of the target substance to the particles. As the feed solution flows in the first direction, the magnetic particles move along a diagonal path from the first side of the vessel to the second side of the vessel under the combined force resulting from the magnetic force and the viscous drag induced by the motion of the fluid in the first direction; the insert in FIG. 6C displays the composition of the two forces. As the magnetic particles move through the feed solution, the target substance binds to them and the feed solution is progressively depleted of it; the particles also disperse because of the variations in their magnetic and hydrodynamic properties. The magnetic particles with the target substance attached to them reach the second side of the column, which is the top edge in FIG. 6A, then flow in the first direction until they reach the second aperture, which is on the top edge on the right hand side in FIG. 6A. A buffer solution, with no effect on the binding of the target substance to the magnetic particles, enters the column through the second aperture. The buffer solution flows out of the column through both outlets of the second end of the column. The buffer solution pushes the feed solution away from the smaller outlet by introducing a slight pressure gradient in the fluid phase towards the first side of the vessel. The magnetic particles enter the kink near the second aperture then move towards the second side of the vessel and are carried out of the column through the smaller outlet by the buffer solution to the next unit operation.

In an embodiment that furthers the embodiment described in FIG. 6, the column consists of a cuboid with length of 1 m, with an inner width of 35 cm and an inner thickness between 0.8 cm and 1.5 cm. The wall of the column is 0.5 mm to 2 mm thick and made of austenitic stainless steel. The second end is divided such that the first outlet has width of 32 cm to 34 cm and the second outlet the complement. The dividing wall has the same thickness as the external wall. The first aperture is circular and has the same inner diameter as the inner thickness of the column. The wall of the first aperture has the same thickness as the external wall of the column. The first aperture is positioned less than 2 cm from the first end of the column. The second aperture is rectangular: the inner height is the same as the thickness of the column; the inner width is between 2 cm and 5 cm and is 0.5 cm to 2 cm wider than the inner width of the second outlet. The wall of the second aperture has the same thickness as the external wall of the column. It is positioned 4 cm to 6 cm from the second end of the column. The magnets are made of neodymium-iron-boron alloys with a magnetic remanence of 1.2 T or higher or 1.25 T or higher. The magnets have a protective coating consisting of three layers: nickel layer, copper layer, nickel layer; the total thickness of the coating must be 15 microns or higher. The magnets are cylinders with a diameter between 1 cm and 2 cm, and with a length equal to 40 cm. The spacing between the magnets is between 1 mm and 2 mm. The magnets are positioned such that the angle between the longitudinal axis of the magnets and the longitudinal axis of the column is 30°. The magnets are positioned such that they fully cover the second aperture. The magnets rotate at a uniform angular velocity between 1·10⁻² rad/s and 5·10⁻¹ rad/s or between 1·10⁻² rad/s and 2·10⁻¹ rad/s. The magnetic particles have a large core made of magnetite encased in a matrix of silica. The magnetic particles are spheroidal with a diameter between 10 microns and 20 microns. Their density is between 2200 kg/m³ and 2700 kg/m³, their overall relative magnetic permeability is at least 1.25, and their magnetisation at saturation is at least 3500 A/m. Between the first and second apertures, the fluid flows with a velocity between 3·10⁻⁴ m/s and 5·10⁻³ m/s or between 3·10⁻⁴ m/s and 3.10⁻³ m/s.

FIGS. 7A and 7B respectively show the top and cross-sectional views of an embodiment of the apparatus according to the present invention. In this embodiment the apparatus performs the elution of a target substance from a bed moving perpendicularly to the direction of the fluid. The bed is moved with static magnets. The column is a vessel in the shape of a hexagonal prism. The hexagonal faces are the top and bottom faces of the column. Two opposing rectangular faces are parallel and longer than the other rectangular faces; these are the first and second sides of the column. Four rectangular faces remain: two of them are identical and adjacent, and form the first end of the column; the two others are identical and adjacent as well, and form the second end of the column. The first end, shown on the right hand side of FIG. 7A, has an inlet at the junction of the two rectangular faces. The second end, shown on the left hand side of FIG. 7A, has an outlet at the junction of the two rectangular faces. The longitudinal axis of the column is the line from the junction of the rectangular faces at the first end to the junction of the rectangular faces at the second end, parallel to the hexagonal faces. The column has eleven apertures: apertures one to four are disposed successively on the first side, aperture one being the closest to the first end and aperture four being the closest to the second end; apertures five to eleven are disposed successively on the second side, aperture five being the closest to the first end and aperture eleven being the closest to the second end. The magnets are cylindrical and their magnetisation is in a direction perpendicular to a longitudinal axis of the magnets. The magnets are positioned above and below the column, at a specific angle to the longitudinal axis of the column; the angle may be adjustable within a range. The magnets extend beyond the edge of the column on each side by a length greater than the thickness of the column between the top and bottom faces.

In FIG. 7B, one layer of magnets is disposed above the column and one layer is disposed below the column. In order to achieve the desired flow of particles, a first end of each magnet positioned over the first side of the vessel is closer to the first end of the vessel than a second end of each magnet positioned over the second side of the vessel, so that when viewed from the top, as shown in FIG. 7A, the magnets are positioned at an angle across the width of the column. The magnets are attached to a fixed non-magnetic support, which is not shown, which permits each magnet to rotate around its axis. The magnets are identical and bear an arrow which shows the direction of their magnetisation in their initial state. Within a layer of magnets, the magnetisations are in a sequence corresponding to a Halbach array. The alternating sequence of the direction of magnetisation of the magnets is matched across the diameter of the column such that the directions of magnetisations of the magnets on one side are the mirror images of the directions of magnetisation of the magnets on the other side of the column.

In use, the magnets rotate at a uniform angular velocity. When they rotate, the set of magnets on one side of the column rotate in the opposite direction to the set of magnets on the other side of the column at constant velocity. In FIG. 7B, this is shown as the magnets above the column rotating clockwise and the magnets below the column rotating anticlockwise. Three different miscible eluents flow into the column through the first, second and third apertures; these eluents flow from the first side of the column towards the second side of the column and mix partially; they then flow out of the column through the apertures five to ten. A buffer solution, named exit buffer, flows into the column through the fourth and eleventh apertures; it flows from the sides of the column towards its axis and partially mixes with the eluents; it flows out of the column though the outlet at the second end of the column. The solution carrying the magnetic particles flows into the column through the inlet at the first end of the column; this solution mixes with the eluents and flows out of the column through apertures five to ten. In the column the fluid flows under pressure gradients. The magnetic particles carrying the target substances enter the column through the inlet at the first end of the column. The magnetic particles move from the first end towards the second end of the column under the combined force resulting from the magnetic force and the viscous drag induced by the motion of the fluid; the insert in FIG. 7C displays the composition of the two forces. As the magnetic particles advance through the column, they disperse due to variations in their magnetic and hydrodynamic properties. However, the overall direction of their movement is perpendicular to the direction of the flow of the eluents. As the magnetic particles move through the column, the target substances progressively disassociate or desorb from them under the influence of the eluents and their mixture. The target substances are dissolved in the eluents and flow out of the column with them through the apertures five to ten. The fluid flowing out of one of these apertures is analogous to a fraction in classical column chromatography and contains a target substance with varying degrees of purity. Each fraction is sent to the next unit operation. Once the magnetic particles reach the second end of the column, they are depleted of target substances and are solvated by the exit buffer, which carries them out of the column through the outlet at the second end of the column to the next unit operation.

In an embodiment that furthers the embodiment described in FIG. 7, the column consists of a vessel shaped as a hexagonal prism. The hexagonal faces are identical and have opposing sides of equal length: two opposite sides are 1 m long and 30 cm apart; the four others are 17 cm long. The hexagonal faces are parallel and positioned 2 cm to 4 cm apart. These dimensions are the inner dimensions of the column. The walls of the column are 0.5 mm to 2 mm thick and made of austenitic stainless steel. The inlet on the first end and the outlet on the second end of the column are identical. The inlet and outlet are rectangular; the edges of the inlet and outlet that are parallel to the rectangular faces are of the same length as the spacing between the hexagonal faces; the edges of the inlet and outlet that are parallel to the hexagonal faces are 1 cm to 2 cm long. The apertures are rectangular; the edges of the apertures that are parallel to the rectangular faces are of the same length as the spacing between the hexagonal faces. The edges of the fourth to eleventh aperture that are parallel to the hexagonal faces are 1 cm to 3 cm long; the edges of the first to third aperture that are parallel to the hexagonal faces are 1 cm to 5 cm long, preferably twice the length of the second side of the fourth to eleventh aperture. These dimensions are the inner dimensions of the apertures. The walls of the apertures have the same thickness as the wall of the column and are made of the same austenitic stainless steel. The fourth and eleventh apertures are positioned near the second end of the column. The first aperture is positioned 10 cm to 20 cm from the first end of the column. The first to third apertures are regularly spaced, the distance between consecutive apertures being between 20 cm and 30 cm. The fifth aperture is positioned 5 cm to 10 cm from the first end of the column. The fifth to tenth apertures are regularly spaced, the distance between consecutive apertures being between 9 cm and 12 cm. The magnets are made of neodymium-iron-boron alloys with a magnetic remanence of 1.2 T or higher. The magnets have a protective coating consisting of three layers: nickel layer, copper layer, nickel layer; the total thickness of the coating must be 15 microns or higher. The magnets are identical cylinders with a diameter between 1 cm and 2 cm, and with a length comprised between to 40 cm and 60 cm. The spacing between the magnets is between 1 mm and 2 mm. The magnets are positioned such that the angle between the longitudinal axis of the magnets and the longitudinal axis of the column is between 30° and 60°. The magnets rotate at a uniform angular velocity between 1·10⁻² rad/s and 5·10⁻¹ rad/s. The magnetic particles have a core made of magnetite encased in a matrix of silica. The magnetic particles are spheroidal with a diameter between 10 microns and 20 microns. The density of the magnetic particles is between 2200 kg/m³ and 2700 kg/m³. The overall relative magnetic permeability of the magnetic particles is at least 1.25, and their magnetisation at saturation is at least 3500 A/m. Between the first and second apertures, the fluid flows with a velocity between 10⁻⁴ m/s and 10⁻² m/s.

1) An apparatus for use in continuous chromatography, said apparatus comprising:
(a) a column made of a material with relative magnetic permeability between 0.95 and 1.05
(b) a bed containing magnetic materials that are free to move inside the column
(c) a device located outside the column generating magnetic fields which move the bed through the column in the same direction as the flow of a fluid, or in the direction opposite to the flow of a fluid, perpendicularly to the flow of a fluid or at angle to the flow of a fluid wherein said fluid is a gas or liquid flowing through the column.

2) The apparatus of claim 1 wherein the bed is made of independent magnetic particles, the size of which ranges from 10 nm to 1 cm.

3) (canceled)

4) The apparatus of claim 2 wherein the magnetic particles comprise two layers:
(a) an inner layer exhibiting magnetic properties
(b) an outer layer exhibiting chromatographic behavior.

5) The apparatus of claim 4 wherein the magnetic particles comprise additional middle layers which do not interfere with the magnetic properties and the chromatographic behavior.

6) The apparatus of claim 2 wherein the material giving the particles their magnetic properties is either a ferromagnetic material, a ferrimagnetic material, a paramagnetic material, a superparamagnetic material, or a diamagnetic material; or wherein the material giving the particles their chromatographic properties is made of any chromatographic resin or material which can be produced in the form of small particles.

7) (canceled)

8) The apparatus of claim 1 wherein the bed comprises at least one distinct porous matrix, each matrix spanning the whole width of the column and permeated by a continuous network of pores.

9) The apparatus of claim 8 wherein the pores in the matrix have sizes ranging from 10 μm to 100 μm; or wherein the matrix is made by cross-linking the magnetic particles; wherein the matrix comprises a chromatographic monolith wherein in the backbone of the monolith magnetic particles are embedded, wherein said magnetic particles comprise either a ferromagnetic material, or a ferrimagnetic material, or a paramagnetic material, or a superparamagnetic material, or a diamagnetic material; or wherein the matrix comprises a chromatographic monolith to which magnetic particles are attached, wherein said magnetic particles comprise either a ferromagnetic material, or a ferrimagnetic material, or a paramagnetic material, or a superparamagnetic material, or a diamagnetic material.

10)-12) (canceled)

13) The apparatus of claim 1 wherein the column is a single vessel or a set of vessels functioning in parallel, wherein the column of vessels are cylindrical vessels, or cuboid vessels or prismatic vessels; or wherein each vessel has at least one aperture.

14)-20) (canceled)

21) The apparatus of claim 13 wherein the permanent magnets are cylindrical magnets and are allowed to rotate along their longitudinal axis, or wherein the permanent magnets are orientated such that the axis of rotation of the magnets is at a specific angle to the longitudinal axis of the column.

22)-24) (canceled)

25) The apparatus of claim 21 wherein the support to which the magnets are attached permits the angle between the axis of rotation of the magnets and the longitudinal axis of the column to be adjusted.

26) The apparatus of claim 1 wherein the magnets are provided on one side of the column.

27) The apparatus of claim 1 wherein the magnets are provided on opposite sides of the column.

28) The apparatus of claim 27 wherein the magnets on either side of the column are symmetrically positioned with respect to the mid-plane of the column, or wherein the magnets on one side of the column are translated with respect to the magnets on the other side of the column in a direction perpendicular to the longitudinal axis of the magnets.

29) (canceled)

30) The apparatus of claim 1 wherein the magnets form an alternating array, or wherein the magnets form a Halbach array, or wherein in their initial sequence the magnets are arranged in a repeating pattern, wherein, n is an integer indicating the position of magnet in its layer, and n is increases in the direction of the flow of magnetic particles, and the origin n=0 is set on any magnet such that the magnetisation of the magnet in the position n−1 is in the same direction and that magnetisation of the magnet in position n+1 is in another direction.

31)-46) (canceled)

47) The apparatus of claim 1 wherein the whole apparatus is encased in a material providing magnetic shielding.

48) A method for performing continuous chromatography using an apparatus which comprises a column made of a material with relative magnetic permeability between 0.95 and 1.05, a bed containing magnetic materials that are free to move inside the column and a device located outside the column, the device comprising one or more permanent magnets that are attached to a fixed support and configured to be rotatable or able to rotate along an axis and adapted so as to rotate during use of the apparatus, wherein rotation of the one or more permanent magnets creates magnetic fields which move the bed through the column in the same direction as the flow of a fluid, or in the direction opposite to the flow of a fluid, perpendicularly to the flow of a fluid or at angle to the flow of a fluid wherein said fluid is a gas or liquid flowing through the column, said method comprising:
(a) a loading operation wherein a feed solution is contacted with a chromatographic material containing magnetic materials and one or several target substances bind to the chromatographic material
(b) an optional washing operation wherein any substance from the feed solution that is not bound to the chromatographic material is carried away by another solution
(c) an elution operation wherein the chromatographic material is contacted with one or several eluents and the one or several target substances are released from the chromatographic material then carried away by the one or several eluents
(d) an optional regeneration operation wherein the chromatographic material is contacted with a solution which restores it to its initial state,
wherein the bed of the apparatus further comprises the chromatographic material used in one or more of operations (a) to (d), and the one or more permanent magnets are rotated during one or more of operations (a) to (d) thereby creating magnetic fields which move the bed through the column in the same direction as the flow of a fluid, or in the direction opposite to the flow of a fluid, perpendicularly to the flow of a fluid or at angle to the flow of a fluid, wherein said fluid is a gas or liquid flowing through the column.

49)-58) (canceled)

59) The method of claim 48 wherein one or more operations are performed by one or more apparatuses.

60. The method of claim 48 wherein two consecutive operations are performed by one apparatus.

61. The method of claim 48 wherein a single solution, or two or more different solutions flow through the column.

62. The method of claim 48 wherein the rotation of the magnets causes zones of strong magnetic field gradients to move and distort contiguously, which in turn induces and controls the movement of the bed.
